(19) United States
(12) Patent Application Publication
(10) Pub. No.: US 2024/0397301 A1
(43) Pub. Date: Nov. 28, 2024

(54) REMOTE USER EQUIPMENT DISCOVERY AND LINK ESTABLISHMENT FOR REDUCED CAPABILITY USER EQUIPMENT

(71) Applicant: QUALCOMM Incorporated, San Diego, CA (US)

(72) Inventors: Peng CHENG, Beijing (CN); Gavin Bernard HORN, La Jolla, CA (US); Karthika PALADUGU, Hyderabad (IN); Ozcan OZTURK, San Diego, CA (US); Linhai HE, San Diego, CA (US); Hong CHENG, Basking Ridge, NJ (US)

(21) Appl. No.: 18/700,656

(22) PCT Filed: Dec. 31, 2021
(86) PCT No.: PCT/CN2021/143611

§ 371 Date: Apr. 11, 2024

(51) Int. Cl. H04W 8/00; H04W 72/0457; H04W 72/51; H04W 76/14; H04W 92/18

(52) U.S. Cl. CPC H04W 8/005; H04W 72/0457; H04W 72/51; H04W 76/14; H04W 92/18

(57) ABSTRACT

Methods, systems, and devices for remote user equipment (UE) discovery and link establishment for reduced capability UE are described. In some examples, a relay UE may transmit one or more discovery messages associated with establishing a sidelink relay communication link between the relay UE and a remote UE having a reduced communication bandwidth capability relative to the relay UE. In such examples, the relay UE may perform a communication bandwidth configuration procedure with the remote UE based on the remote UE having the reduced communication bandwidth capability relative to the relay UE. In some examples, the relay UE and the remote UE may establish, in accordance with the communication bandwidth configuration procedure, the sidelink relay communication link between the relay UE and the remote UE using a reduced communication bandwidth that is less than a full communication bandwidth allocated for the relay UE.

### CROSS REFERENCE

The present Application is a 371 national stage filing of International PCT Application No. PCT/CN2021/143611 by CHENG et al. entitled “REMOTE USER EQUIPMENT DISCOVERY AND LINK ESTABLISHMENT FOR REDUCED CAPABILITY USER EQUIPMENT,” filed Dec. 31, 2021, which is assigned to the assignee hereof, and which is expressly incorporated by reference in its entirety herein.

### FIELD OF TECHNOLOGY

The following relates to wireless communications, including remote user equipment discovery and link establishment for reduced capability user equipment.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

In some examples, wireless devices such as UEs may be configured with reduced capabilities, which may present limitations in establishing relay communication links.

### SUMMARY

The described techniques relate to improved methods, systems, devices, and apparatuses that support remote user equipment (UE) discovery and link establishment for reduced capability UE. Generally, the described techniques provide for a relay UE to transmit one or more discovery messages to the remote UE considering one or more reduced capability features of the remote UE, the relay UE, or both. In some examples, the relay UE may transmit one or more discovery messages to the remote UE using a reduced communication bandwidth associated with a reduced capability of the remote UE, the full communication bandwidth associated with a communication capability of the relay UE, or a combination of bandwidths. The remote UE may receive the one or more discovery messages using the reduced communication bandwidth, the full communication bandwidth, or both and may determine whether to select the relay UE for link establishment.

A method for wireless communication at a relay UE is described. The method may include transmitting one or more discovery messages associated with establishing a sidelink relay communication link between the relay UE and a remote UE having a reduced communication bandwidth capability relative to the relay UE, performing a communication bandwidth configuration procedure with the remote UE based on the remote UE having the reduced communication bandwidth capability relative to the relay UE, and establishing, in accordance with the communication bandwidth configuration procedure, the sidelink relay communication link between the relay UE and the remote UE using a reduced communication bandwidth that is less than a full communication bandwidth allocated for the relay UE.

An apparatus for wireless communication at a relay UE is described. The apparatus may include a processor, memory coupled with the processor, and instructions stored in the memory. The instructions may be executable by the processor to cause the apparatus to transmit one or more discovery messages associated with establishing a sidelink relay communication link between the relay UE and a remote UE having a reduced communication bandwidth capability relative to the relay UE, perform a communication bandwidth configuration procedure with the remote UE based on the remote UE having the reduced communication bandwidth capability relative to the relay UE, and establish, in accordance with the communication bandwidth configuration procedure, the sidelink relay communication link between the relay UE and the remote UE using a reduced communication bandwidth that is less than a full communication bandwidth allocated for the relay UE.

Another apparatus for wireless communication at a relay UE is described. The apparatus may include means for transmitting one or more discovery messages associated with establishing a sidelink relay communication link between the relay UE and a remote UE having a reduced communication bandwidth capability relative to the relay UE, means for performing a communication bandwidth configuration procedure with the remote UE based on the remote UE having the reduced communication bandwidth capability relative to the relay UE, and means for establishing, in accordance with the communication bandwidth configuration procedure, the sidelink relay communication link between the relay UE and the remote UE using a reduced communication bandwidth that is less than a full communication bandwidth allocated for the relay UE.

A non-transitory computer-readable medium storing code for wireless communication at a relay UE is described. The code may include instructions executable by a processor to transmit one or more discovery messages associated with establishing a sidelink relay communication link between the relay UE and a remote UE having a reduced communication bandwidth capability relative to the relay UE, perform a communication bandwidth configuration procedure with the remote UE based on the remote UE having the reduced communication bandwidth capability relative to the relay UE, and establish, in accordance with the communication bandwidth configuration procedure, the sidelink relay communication link between the relay UE and the remote UE using a reduced communication bandwidth that is less than a full communication bandwidth allocated for the relay UE.

In some examples of the method, apparatuses, and non-transitory computer-readable medium described herein, transmitting the one or more discovery messages may include operations, features, means, or instructions for transmitting the one or more discovery messages with broadcast signaling in a resource pool corresponding to the reduced communication bandwidth.

In some examples of the method, apparatuses, and non-transitory computer-readable medium described herein, transmitting the one or more discovery messages may include operations, features, means, or instructions for transmitting the one or more discovery messages with broadcast signaling in a resource pool corresponding to the full communication bandwidth allocated for the relay UE.

In some examples of the method, apparatuses, and non-transitory computer-readable medium described herein, transmitting the one or more discovery messages may include operations, features, means, or instructions for transmitting a first set of discovery messages with broadcast signaling in a first resource pool corresponding to the full communication bandwidth allocated for the relay UE and transmitting a second set of discovery messages with broadcast signaling in a second resource pool corresponding to the reduced communication bandwidth.

Some examples of the method, apparatuses, and non-transitory computer-readable medium described herein may further include operations, features, means, or instructions for transmitting an indication, to a base station, indicating that the remote UE may have the reduced communication bandwidth capability relative to the relay UE.

In some examples of the method, apparatuses, and non-transitory computer-readable medium described herein, transmitting the indication may include operations, features, means, or instructions for transmitting the indication via a dedicated radio resource control (RRC) message while the relay UE may be in an RRC connected state with the base station.

In some examples of the method, apparatuses, and non-transitory computer-readable medium described herein, transmitting the indication may include operations, features, means, or instructions for transmitting the indication without transitioning to an RRC connected state while the relay UE may be in an RRC idle state or an RRC inactive state with the base station.

In some examples of the method, apparatuses, and non-transitory computer-readable medium described herein, transmitting the indication may include operations, features, means, or instructions for transmitting the indication via a dedicated logical channel identifier (LCID) that may be configured for indicating that the remote UE may have the reduced communication bandwidth capability relative to the relay UE.

In some examples of the method, apparatuses, and non-transitory computer-readable medium described herein, transmitting the indication may include operations, features, means, or instructions for transmitting the indication via an RRC message associated with the relay UE establishing or resuming a communication link with the base station.

In some examples of the method, apparatuses, and non-transitory computer-readable medium described herein, transmitting the one or more discovery messages may include operations, features, means, or instructions for transmitting a cell barring indication in the one or more discovery messages, the cell barring indication indicating one or more receiving chains for the remote UE.

In some examples of the method, apparatuses, and non-transitory computer-readable medium described herein, the remote UE may be configured with one or more reduced capabilities relative to the relay UE and the one or more reduced capabilities include a limitation on a maximum number of data radio bearers (DRBs), a lack of support for carrier aggregation, a lack of support for dual connectivity, a limitation on a number of supported receiver chains, or a combination thereof.

In some examples of the method, apparatuses, and non-transitory computer-readable medium described herein, the sidelink relay communication link may be a PC5 communication link.

In some examples of the method, apparatuses, and non-transitory computer-readable medium described herein, the one or more discovery messages includes a first indication of whether the relay UE supports the reduced communication bandwidth, the full communication bandwidth, or both for a connection with a base station, a second indication of whether the relay UE supports the reduced communication bandwidth, the full communication bandwidth, or both for a sidelink connection, or a combination of the first indication and the second indication.

A method for wireless communication at a remote UE is described. The method may include receiving one or more discovery messages associated with establishing a sidelink relay communication link between a relay UE and the remote UE, where the remote UE has a reduced communication bandwidth capability relative to the relay UE, performing a communication bandwidth configuration procedure with the relay UE based on the remote UE having the reduced communication bandwidth capability relative to the relay UE, and establishing, in accordance with the communication bandwidth configuration procedure, the sidelink relay communication link between the relay UE and the remote UE using a reduced communication bandwidth that is less than a full communication bandwidth allocated for the relay UE.

An apparatus for wireless communication at a remote UE is described. The apparatus may include a processor, memory coupled with the processor, and instructions stored in the memory. The instructions may be executable by the processor to cause the apparatus to receive one or more discovery messages associated with establishing a sidelink relay communication link between a relay UE and the remote UE, where the remote UE has a reduced communication bandwidth capability relative to the relay UE, perform a communication bandwidth configuration procedure with the relay UE based on the remote UE having the reduced communication bandwidth capability relative to the relay UE, and establish, in accordance with the communication bandwidth configuration procedure, the sidelink relay communication link between the relay UE and the remote UE using a reduced communication bandwidth that is less than a full communication bandwidth allocated for the relay UE.

Another apparatus for wireless communication at a remote UE is described. The apparatus may include means for receiving one or more discovery messages associated with establishing a sidelink relay communication link between a relay UE and the remote UE, where the remote UE has a reduced communication bandwidth capability relative to the relay UE, means for performing a communication bandwidth configuration procedure with the relay UE based on the remote UE having the reduced communication bandwidth capability relative to the relay UE, and means for establishing, in accordance with the communication bandwidth configuration procedure, the sidelink relay communication link between the relay UE and the remote UE using a reduced communication bandwidth that is less than a full communication bandwidth allocated for the relay UE.

A non-transitory computer-readable medium storing code for wireless communication at a remote UE is described. The code may include instructions executable by a processor to receive one or more discovery messages associated with establishing a sidelink relay communication link between a relay UE and the remote UE, where the remote UE has a reduced communication bandwidth capability relative to the relay UE, perform a communication bandwidth configuration procedure with the relay UE based on the remote UE having the reduced communication bandwidth capability relative to the relay UE, and establish, in accordance with the communication bandwidth configuration procedure, the sidelink relay communication link between the relay UE and the remote UE using a reduced communication bandwidth that is less than a full communication bandwidth allocated for the relay UE.

In some examples of the method, apparatuses, and non-transitory computer-readable medium described herein, receiving the one or more discovery messages may include operations, features, means, or instructions for receiving the one or more discovery messages over broadcast signaling in a resource pool corresponding to the reduced communication bandwidth.

In some examples of the method, apparatuses, and non-transitory computer-readable medium described herein, receiving the one or more discovery messages may include operations, features, means, or instructions for receiving the one or more discovery messages over broadcast signaling in a resource pool corresponding to the full communication bandwidth allocated for the relay UE.

In some examples of the method, apparatuses, and non-transitory computer-readable medium described herein, receiving the one or more discovery messages may include operations, features, means, or instructions for receiving a first set of discovery messages over broadcast signaling in a first resource pool corresponding to the full communication bandwidth allocated for the relay UE and receiving a second set of discovery messages over broadcast signaling in a second resource pool corresponding to the reduced communication bandwidth.

In some examples of the method, apparatuses, and non-transitory computer-readable medium described herein, receiving the one or more discovery messages may include operations, features, means, or instructions for receiving a cell barring indication in the one or more discovery messages, the cell barring indication indicating one or more receiving chains for the remote UE.

Some examples of the method, apparatuses, and non-transitory computer-readable medium described herein may further include operations, features, means, or instructions for selecting the relay UE for establishing the sidelink relay communication link based on the relay UE supporting the reduced communication bandwidth for a sidelink communication, the relay UE supporting the reduced communication bandwidth for a communication link with a base station, or a combination thereof.

In some examples of the method, apparatuses, and non-transitory computer-readable medium described herein, selecting the relay UE may include operations, features, means, or instructions for selecting the relay UE based on a priority associated with the relay UE supporting the reduced communication bandwidth for the sidelink communication or the relay UE supporting the reduced communication bandwidth for the communication link with the base station.

In some examples of the method, apparatuses, and non-transitory computer-readable medium described herein, the remote UE may be configured with one or more reduced capabilities relative to the relay UE and the one or more reduced capabilities include a limitation on a maximum number of DRBs, a lack of support for carrier aggregation, a lack of support for dual connectivity, a limitation on a number of supported receiver chains, or a combination thereof.

In some examples of the method, apparatuses, and non-transitory computer-readable medium described herein, the sidelink relay communication link may be a PC5 communication link.

In some examples of the method, apparatuses, and non-transitory computer-readable medium described herein, the one or more discovery messages includes a first indication of whether the relay UE supports the reduced communication bandwidth, the full communication bandwidth, or both for a connection with a base station, a second indication of whether the relay UE supports the reduced communication bandwidth, the full communication bandwidth, or both for a sidelink connection, or a combination of the first indication and the second indication

### BRIEF DESCRIPTION OF THE DRAWINGS

FIGS. 1 and 2 illustrate examples of wireless communications systems that support remote user equipment (UE) discovery and link establishment for reduced capability UE in accordance with aspects of the present disclosure.

FIGS. 3A, 3B, and 3C illustrate examples of resource diagrams that support remote UE discovery and link establishment for reduced capability UE in accordance with aspects of the present disclosure.

FIG. 4 illustrates an example of a process flow that supports remote UE discovery and link establishment for reduced capability UE in accordance with aspects of the present disclosure.

FIGS. 5 and 6 show block diagrams of devices that support remote UE discovery and link establishment for reduced capability UE in accordance with aspects of the present disclosure.

FIG. 7 shows a block diagram of a communications manager that supports remote UE discovery and link establishment for reduced capability UE in accordance with aspects of the present disclosure.

FIG. 8 shows a diagram of a system including a device that supports remote UE discovery and link establishment for reduced capability UE in accordance with aspects of the present disclosure.

FIGS. 9 and 10 show block diagrams of devices that support remote UE discovery and link establishment for reduced capability UE in accordance with aspects of the present disclosure.

FIG. 11 shows a block diagram of a communications manager that supports remote UE discovery and link establishment for reduced capability UE in accordance with aspects of the present disclosure.

FIG. 12 shows a diagram of a system including a device that supports remote UE discovery and link establishment for reduced capability UE in accordance with aspects of the present disclosure.

FIGS. 13 through 18 show flowcharts illustrating methods that support remote UE discovery and link establishment for reduced capability UE in accordance with aspects of the present disclosure.

### DETAILED DESCRIPTION

In some examples, devices may support reduced capability remote user equipment (UE) communications via a UE to network (U2N) relay. For example, a relay UE may both communicate with a base station and provide service to a remote UE, which may be a reduced capability remote UE, via a U2N relay. In some examples, discovery of, and link establishment with the remote UE may be constrained by one or more reduced capability features, for example, a reduced communication bandwidth. For example, the relay UE may transmit one or more discovery signals to the remote UE using a full communication bandwidth configured for the relay UE based on the communication capabilities of the relay UE. In such examples, the remote UE may be configured to monitor for signals using a reduced communication bandwidth based on a reduced communication capability of the remote UE, and the remote UE may not be able to decode the one or more discovery signals that are transmitted using a full or otherwise greater communication bandwidth.

In accordance with aspects of the present disclosure, a relay UE may be configured to broadcast or otherwise transmit discovery messages in a way that allows remote UEs having reduced communication capabilities to receive and decode the discovery messages. For example, a relay UE may transmit one or more discovery messages to the remote UE using the reduced communication bandwidth, the full communication bandwidth, or a combination thereof. In some cases, the relay UE may transmit the one or more discovery messages to the remote UE using a resource pool with the reduced communication bandwidth. In other cases, the relay UE may transmit the one or more discovery messages to the remote UE using a resource pool with the full communication bandwidth. In yet other cases, the relay UE may transmit a first set of discovery messages using the resource pool with the reduced communication bandwidth and a second set of discovery messages using the resource pool with the full communication bandwidth. In such examples, UEs having reduced communication capabilities may receive the discovery messages sent using the reduced communication bandwidth, while UEs have full communication capabilities may receive the discovery messages sent using the full communication bandwidth. The remote UE may receive the one or more discovery messages using the reduced communication bandwidth, the full communication bandwidth, or both and may determine whether to select the relay UE for link establishment. In some examples, the remote UE may determine whether to select the relay UE based on a reduced capability operation. In some examples, the remote UE may be a full capability remote UE, and the remote UE may avoid selecting (or reselecting) the relay UE in cases where the relay UE is a reduced capability UE. In other examples, the remote UE may be a reduced capability remote UE and may select (or reselect) a relay UE that supports reduced capabilities.

Aspects of the disclosure are initially described in the context of wireless communications systems. Aspects of the disclosure are then described in the context of resource diagrams and a process flow. Aspects of the disclosure are further illustrated by and described with reference to apparatus diagrams, system diagrams, and flowcharts that relate to remote UE discovery and link establishment for reduced capability UE.

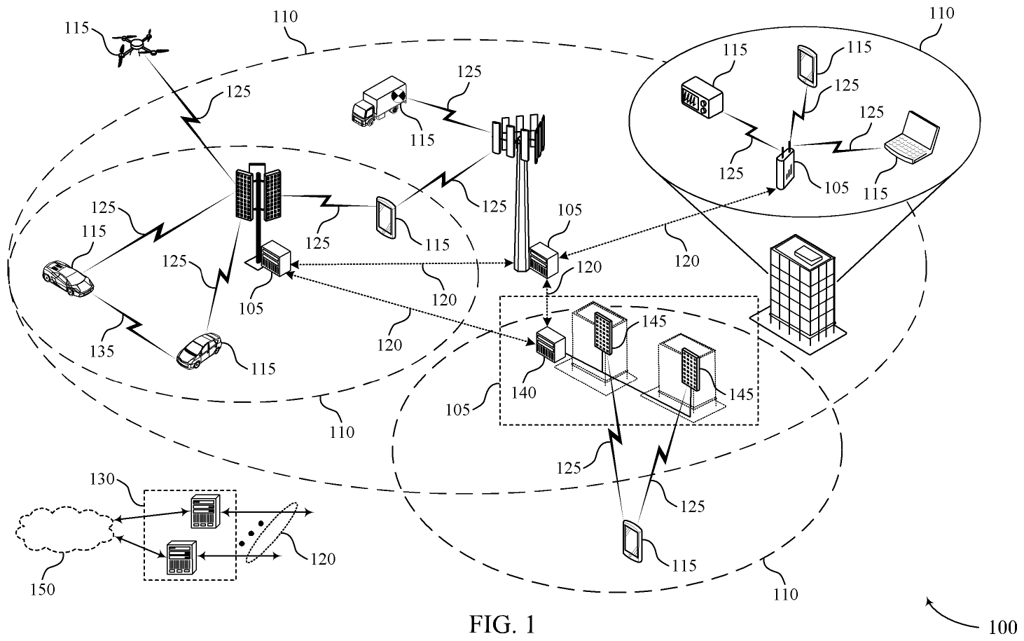

FIG. 1 illustrates an example of a wireless communications system 100 that supports remote UE discovery and link establishment for reduced capability UE in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

In some examples, one or more components of the wireless communications system 100 may operate as or be referred to as a network node. As used herein, a network node may refer to any UE 115, base station 105, entity of a core network 130, apparatus, device, or computing system configured to perform any techniques described herein. For example, a network node may be a UE 115. As another example, a network node may be a base station 105. As another example, a first network node may be configured to communicate with a second network node or a third network node. In one aspect of this example, the first network node may be a UE 115, the second network node may be a base station 105, and the third network node may be a UE 115. In another aspect of this example, the first network node may be a UE 115, the second network node may be a base station 105, and the third network node may be a base station 105. In yet other aspects of this example, the first, second, and third network nodes may be different. Similarly, reference to a UE 115, a base station 105, an apparatus, a device, or a computing system may include disclosure of the UE 115, base station 105, apparatus, device, or computing system being a network node. For example, disclosure that a UE 115 is configured to receive information from a base station 105 also discloses that a first network node is configured to receive information from a second network node. In this example, consistent with this disclosure, the first network node may refer to a first UE 115, a first base station 105, a first apparatus, a first device, or a first computing system configured to receive the information; and the second network node may refer to a second UE 115, a second base station 105, a second apparatus, a second device, or a second computing system.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

In some examples, the wireless communications system 100 may support techniques for a remote UE 115 to establish communications via a U2N relay, where the relay UE 115, the remote UE 115, or both are a reduced capability UE 115. For example, a relay UE 115 may both communicate with a base station 105 and provide service to a remote UE 115. In some examples, the relay UE 115 may be a reduced capability UE 115 while the remote UE 115 is a regular full capability UE 115. In some examples, the relay UE 115 and the remote UE 115 may be reduced capability UEs 115. In some examples, the relay UE 115 may be a full capability UE 115 while the remote UE 115 is a reduced capability UE 115. In some examples, discovery of, and link establishment with the remote UE 115 may be constrained by one or more reduced capability features, for example, a reduced communication bandwidth.

In some examples, the relay UE 115 may transmit one or more discovery messages to the remote UE 115 using one or more techniques that support a relay link establishment involving a reduced capability UE 115. For example, a relay UE 115 may broadcast discovery messages using a reduced communication bandwidth, the full communication bandwidth, or a combination thereof. In some cases, the relay UE 115 may transmit the one or more discovery messages to the remote UE 115 using a resource pool with the reduced communication bandwidth. In other cases, the relay UE 115 may transmit the one or more discovery messages to the remote UE 115 using a resource pool with the full communication bandwidth. In yet other cases, the relay UE 115 may broadcast a first set of the one or more discovery messages using the resource pool with the reduced communication bandwidth and a second set of the one or more discovery messages using the resource pool with the full communication bandwidth. The remote UE 115 may receive the one or more discovery messages using the reduced communication bandwidth, the full communication bandwidth, or both and may determine whether to select the relay UE 115 for link establishment. In some examples, the remote UE 115 may determine whether to select the relay UE 115 based on a reduced capability operation. In some examples, the remote UE 115 may be a full capability remote UE 115, and the remote UE 115 may avoid selecting (or reselecting) the relay UE 115 in cases where the relay UE 115 is a reduced capability UE 115. In other examples, the remote UE 115 may be a reduced capability remote UE 115 and may select (or reselect) a relay UE 115 that supports reduced capabilities.

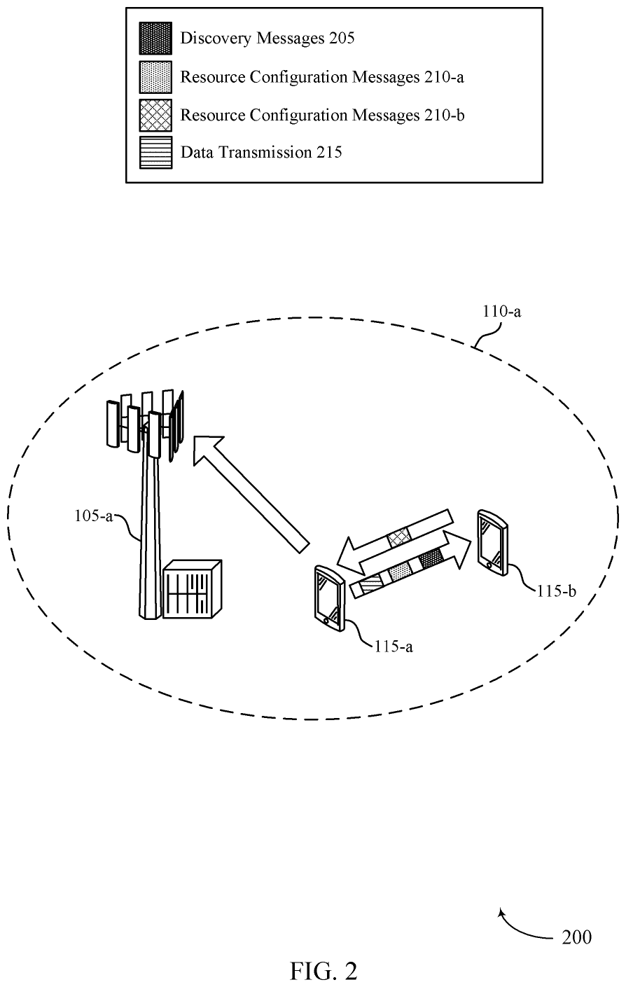

FIG. 2 illustrates an example of a wireless communications system 200 that supports remote UE discovery and link establishment for reduced capability UE in accordance with aspects of the present disclosure. The wireless communications system 200 may implement or be implemented by aspects of the wireless communications system 100. For example, wireless communications system 200 may include a base station 105-a, a UE 115-a, and a UE 115-b which may be examples of corresponding devices as described with reference to FIG. 1. In some examples, the UE 115-a and the UE 115-b may exchange signaling supporting discovery of, and link establishment with the UE 115-b.

Some wireless communications systems may include reduced capability devices (e.g., U-TRAN to UE (Uu) reduced capability devices), such as wearables (e.g., smart watches, wearable medical devices, augmented reality goggles, virtual reality goggles), industrial wireless sensors, video surveillance, among other examples. For example, the UE 115-a, the UE 115-b, or both may be examples of reduced capability UEs 115. In some examples, to reduce a bill of materials cost in terms of antennas and radio frequency components, the reduced capabilities of a reduced capability device compared to other devices may include bandwidth reduction, a maximum MIMO layer reduction, a relaxation of a maximum downlink modulation order (e.g., to reduce a baseband complexity), a minimum number of receive branch (e.g., chain, communication link) reduction, and enabling half-duplex (HD) operations. For example, the UE 115-b may be a reduced capability UE 115-b where the UE 115-b may use a reduced bandwidth, a reduced maximum number of MIMO layers, a smaller maximum downlink modulation order (e.g., as compared to non-reduced capability devices which may be equivalently referred to as full capability devices), a reduced minimum number of receive branches, and may communicate with other devices using HD communications.

In some examples, devices may support reduced capability remote UE 115 communications via a U2N relay. For example, the UE 115-a may be a relay UE 115-a communicating with the base station 105-a and providing service to the UE 115-b, a reduced capability remote UE 115-b, via a U2N relay. In some cases, the UE 115-a may support similar performance as the connection to the base station 105-a for the reduced capability remote UE 115-b via the U2N relay. Reduced capability devices may connect to the network via a U2N relay in cases where the reduced capability devices are located outside of network coverage or to save power (e.g., by connecting over a local link). For example, the reduced capability remote UE 115-b may be located outside of coverage area 110-a and may request network service from the UE 115-a via the U2N relay. In some examples, the UE 115-a may be a reduced capability relay UE 115-a, where the reduced capability features of the UE 115-a may be extended when connected to the UE 115-b via the U2N relay to achieve similar power savings as the reduced capability remote UE 115-b.

Wireless communications systems supporting reduced capability features for a remote UE 115 connected via a U2N relay may have one or more use cases. Some wireless communications systems may use reduced capability Uu connections and full capability sidelink connections. That is, the UE 115-a may be a Uu reduced capability UE 115-a while both the UE 115-a and the UE 115-b may be sidelink full capability UEs 115. Some wireless communications systems may use reduced capability Uu connections and reduced capability sidelink connections. For example, the UE 115-a may be a Uu reduced capability UE 115-a and a sidelink reduced capability UE 115-a and the UE 115-b may be a sidelink reduced capability UE 115-b. Some wireless communications systems may use full capability Uu connections and reduced capability sidelink connections. For example, the UE 115-a may be a sidelink reduced capability UE 115-a, the UE 115-b may be a sidelink reduced capability UE 115-b, or both. Such use cases may specify impacts to remote UE 115 discovery and relay UE 115 selection and reselection procedures considering reduced capability aspects.

Uu reduced capability UEs 115 may be constrained by one or more features (e.g., related to an upper layer). In some examples, there may be a single type of Uu reduced capability UE 115. That is, a Uu reduced capability UE 115 may be configured with the Uu reduced capability UE 115 features. Such features may include the use of a maximum of 8 data radio bearers (DRBs), using 12 bits for a sequence number in cases where Uu reduced capability UEs 115 are in a PDCP or RLC acknowledgement mode (e.g., 18 bits for the sequence number may optionally be supported). In some examples, Uu reduced capability UEs 115 features may maintain inter-radio access technology (RAT) handover related features, measurement related features, URLLC related features, and IAB related capability features.

In wireless communications system 200, three reduced capability scenarios may be supported. For example, in a first case, the base station 105-a and the UE 115-a may communicate using reduced capability Uu communications and the UE 115-a may provide service to the UE 115-b using full capability sidelink communications. In a second case, the base station 105-a and the UE 115-a may communicate using full capability Uu communications and the UE 115-a may provide service to the UE 115-b using reduced capability sidelink communications. In a third case, the base station 105-a and the UE 115-a may communicate using reduced capability Uu communications and the UE 115-a may provide service to the UE 115-b using reduced capability sidelink communications. Ins some examples, the wireless communications system 200 may experience one or more impacts due to reduced capability exposure, for example in discovery signaling, relay selection (or reselection) procedures, or a combination thereof. There may be one or more constraints for each of the three cases provided herein, for example, with reference to Table 1.

TABLE 1

| | Max | Receiver | | | |
|---|---|---|---|---|---|
| | DRB | antenna # | Max bandwidth | PDCP SN | RLC SN |
| Case 1 | 8 | Up to 4 | 20 MHz (restricted | 12 | 18 |
| | | | by Uu bandwidth) | | |
| Case 2 | 8 | Up to 2 | Restricted by | 12 | 12 |
| | | | reduced capability | | |
| | | | sidelink bandwidth | | |
| Case 3 | 8 | Up to 2 | Restricted by | 12 | 12 |
| | | | reduced capability | | |
| | | | sidelink bandwidth | | |

Sidelink reduced capability UEs 115 may be constrained by one or more features. In some examples, a sidelink reduced capability UE 115 may be configured with such reduced capability UE 115 features, including the use of a maximum of 8 DRBs, using 12 bits for a sequence number in cases where sidelink reduced capability UEs 115 are in a PDCP or RLC acknowledgement mode for a PC5 link, lacking support for carrier aggregation in PC5 links, lacking support for dual connectivity in PC5 links, restriction to a single receiving chain or two receiving chains (e.g., lower layer related), supporting a path switch (e.g., for a communication link), refraining from including a PC5 service data adaptation protocol (SDAP) header (e.g., in cases where there may be a one-to-one bearer mapping), refraining from including an adaptation layer header (e.g., in cases where reflective quality of service (QOS) may not be supported), or a combination thereof.

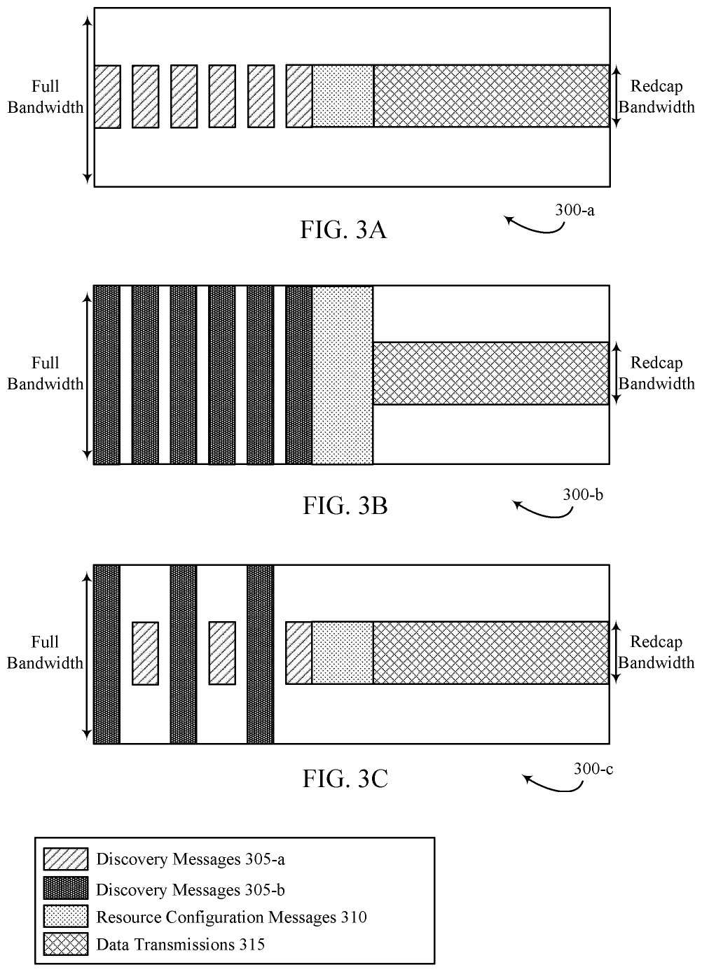

In some examples, discovery messages 205 may be impacted by reduced capability features. For example, the UE 115-a may transmit one or more discovery messages 205 to the UE 115-b to establish a PC5 link. The UE 115-a may transmit the one or more discovery messages in accordance with resource configurations as described with reference to FIGS. 3A through 3B. In some examples, in discovery messages 205, the UE 115-a may include two bits associated with reduced capability indications, where the two bits may include a first bit indicating support for only Uu reduced capability UEs 115 and a second bit indicating support for only sidelink reduced capability UEs 115. In such cases, the UE 115-b may receive the one or more discovery messages 205 and may determine whether to select the UE 115-a for the PC5 link. For example, the UE 115-b may determine whether to select the UE 115-a based on a reduced capability operation. In some examples, the UE 115-b may be a full capability remote UE 115-b, and the UE 115-b may avoid selecting (or reselecting) the UE 115-a in cases where the UE 115-a is a Uu reduced capability UE 115-a. In other examples, the UE 115-b may be a reduced capability remote UE 115-b and may select (or reselect) a relay UE 115 that supports either sidelink reduced capabilities, Uu reduced capabilities, or a combination thereof. That is, the UE 115-b may be a sidelink reduced capability UE 115 and may select (or reselect) the UE 115-a for the PC5 link based on the UE 115-a having sidelink reduced capabilities, Uu reduced capabilities, or a combination thereof. In some cases, the UE 115-b may select the 115-a based on a priority associated with sidelink reduced capabilities and Uu reduced capabilities. For example, the UE 115-a may be configured with both sidelink reduced capabilities and the UE 115-b may determine to connect with the UE 115-a based on sidelink reduced capabilities being prioritized over Uu reduced capabilities. In such cases, the priority may be configured such that the UE 115-b may be configured to prioritize sidelink reduced capabilities or Uu reduced capabilities. In some examples, after transmission of the discovery messages 205, the UE 115-a and UE 115-b may exchange signaling (e.g., resource configuration message 210-a and resource configuration message 210-b) to establish a communication bandwidth and other configurations for establishing a sidelink communication link between UE 115-a and UE 115-b. Upon establishing the communication link, a data transmission 215 may be transmitted between UE 115-a and UE 115-b and relayed to the base station 105-a in accordance with the relay configuration.

Configuring relay UEs 115 to transmit discovery messages 205 considering reduced capabilities and configuring remote UEs 115 to select relay UEs 115 considering reduced capabilities may improve network function at least in part due to enhanced communication efficiency and improved coordination between devices.

FIGS. 3A, 3B, and 3C illustrate examples of resource diagrams 300 that support remote UE discovery and link establishment for reduced capability UE in accordance with aspects of the present disclosure. The resource diagrams 300 may be implemented by a base station, or a UE, or both, which may be examples of a base station 105 or a UE 115 as described with reference to FIGS. 1 and 2. For example, the relay UE 115-a may transmit signaling to the remote UE 115-b in accordance with the resource diagrams 300, supporting discovery and link establishment for reduced capability devices. Resource diagrams 300 may demonstrate example resource diagrams and may include any number of resource elements, and any number of TTIs (e.g., symbols, slots). For example, resource diagrams 300 may each include a slot, where discovery messages 305, resource configuration messages 310, and data transmissions 315 may each be allocated respective symbols.

In some examples, the resource diagrams 300 may be associated with unicast reduced capability PC5 link establishment. For example, the resource diagrams may be associated with establishing a U2N relay between a relay UE and a remote UE. In some examples, the relay UE may support both full capability remote UE and reduced capability remote UE discovery and link establishment, where in some cases, reduced capability remote UEs may be unable to successfully receive the relay UE discovery messages using full communication bandwidths.

In some examples, FIG. 3A may depict a resource diagram 300-a, where the relay UE may transmit discovery messages 305-a in dedicated resource pools with a reduced communication bandwidth (e.g., as described with reference to FIG. 2). In such cases, a link setup between the relay UE and the remote UE may establish a unicast PC5 link with the same bandwidth as the discovery messages 305-a (e.g., the reduced communication bandwidth).

In some examples, the remote UE may receive the discovery messages 305-a and may select (or reselect) the relay UE for link establishment. For example, the remote UE may select (or reselect) the relay UE in accordance with the relay UE supporting reduced capabilities as described with reference to FIG. 2. In some examples, the relay UE may transmit one or more resource configuration messages 310 to the remote UE to allocate or reserve transmission resources. For example, the relay UE may transmit a dynamic channel allocation message (DCA), a dynamic channel reservation (DCR) message, or a combination thereof, to configure (or negotiate) resource assignment for one or more subsequent messages. In the example of resource diagram 300-a, the relay UE may transmit the resource configuration messages 310 to the remote UE using the reduced communication bandwidth. In some examples, the relay UE may transmit data transmissions 315 to the remote UE using the configured bandwidth (e.g., the reduced communication bandwidth) and using the agreed upon resources.

In some examples, FIG. 3B may depict a resource diagram 300-b, where the relay UE may transmit discovery messages 305-b in dedicated resource pools with a full communication bandwidth. In such cases, a link setup between the relay UE and the remote UE may involve negotiation of a sidelink reduced capability configuration, for example, considering a reduced communication bandwidth and in what time frame the reduced communication bandwidth may be applied. In such examples, the remote UE may be configured to monitor for, and receive, the discovery messages 305-b using the full communication bandwidth.

In some examples, the remote UE may receive the discovery messages 305-b and may select (or reselect) the relay UE for link establishment. For example, the remote UE may select (or reselect) the relay UE in accordance with the relay UE supporting reduced capabilities as described with reference to FIG. 2. In some examples, the relay UE may transmit one or more resource configuration messages 310 to the remote UE to allocate or reserve transmission resources. For example, the relay UE may transmit a dynamic channel allocation message (DCA), a dynamic channel reservation (DCR) message, or a combination thereof, to configure (or negotiate) resource assignment for one or more subsequent messages. In the example of resource diagram 300-b, the relay UE may transmit the resource configuration messages 310 to the remote UE using the full communication bandwidth. In some examples, the relay UE may transmit data transmissions 315 to the remote UE using the configured bandwidth (e.g., the reduced communication bandwidth) and using the agreed upon resources.

In some examples, FIG. 3C may depict a resource diagram 300-c, where the relay UE may transmit discovery messages 305-a in dedicated resource pools with the reduced communication bandwidth (e.g., as described with reference to FIG. 2) and may transmit discovery messages 305-b in a resource pool with the full communication bandwidth. In such cases, a link setup between the relay UE and the remote UE may establish a unicast PC5 link with the same bandwidth as the discovery messages 305-a or the discovery messages 305-b.

In some examples, the remote UE may receive the discovery messages 305-a, the discovery messages 305-b, or both. In some cases, the remote UE may be a reduced capability UE and may receive the discovery messages 305-a in the dedicated resource pools with the reduced communication bandwidth. In other cases, the remote UE may be a full capability UE and may receive the discovery messages 305-b in the resource pools with the full communication bandwidth. In some examples, the remote UE may select (or reselect) the relay UE for link establishment. For example, the remote UE may select (or reselect) the relay UE in accordance with the relay UE supporting reduced capabilities as described with reference to FIG. 2. In some examples, the relay UE may transmit one or more resource configuration messages 310 to the remote UE to allocate or reserve transmission resources. For example, the relay UE may transmit a dynamic channel allocation message (DCA), a dynamic channel reservation (DCR) message, or a combination thereof, to configure (or negotiate) resource assignment for one or more subsequent messages. In the example of resource diagram 300-a, the relay UE may transmit the resource configuration messages 310 to the remote UE using the reduced communication bandwidth. In some examples, the relay UE may transmit data transmissions 315 to the remote UE using the configured bandwidth (e.g., the reduced communication bandwidth) and using the agreed upon resources.

In some examples, the relay UE may transmit a cell barring indication to the remote UE. For example, the relay UE may transmit the cell barring indication for the remote UE to use one receiving chain, two receiving chains, or both, in an enhanced system information block (E-SIB) (i.e., in the relay UE discovery messages 305).

In some examples, the relay UE may transmit an indication to a base station, indicating that the remote UE is a reduced capability UE. For example, after the relay UE performs the unicast PC5 link setup with the reduced capability remote UE, the relay UE may transmit the indication to the base station. In some examples, the relay UE may be in an RRC connected state with the base station, where the relay UE may transmit the indication to the base station via a dedicated RRC message. In other examples, the remote UE may be in an idle or inactive state, where the relay UE may forward the indication to the base station without transitioning to an RRC connected state. In some cases, the relay UE may transmit the indication via a small data transmission (SDT) like procedure without transitioning to an RRC connected state (e.g., an SDT procedure in a layer 2 (L2) relay). In other cases, the relay UE may transmit the indication in a dedicated LCID field in a message 3 (msg3). In yet other cases, the remote UE may piggy-back the indication in an RRC establishment or RRC resume request message used for the remote UE to establish (or reestablish) communications with the base station.

The techniques as described herein may provide for a more expedited discovery and link establishment with remote UEs when establishing U2N relays, resulting in enhanced communication efficiency.

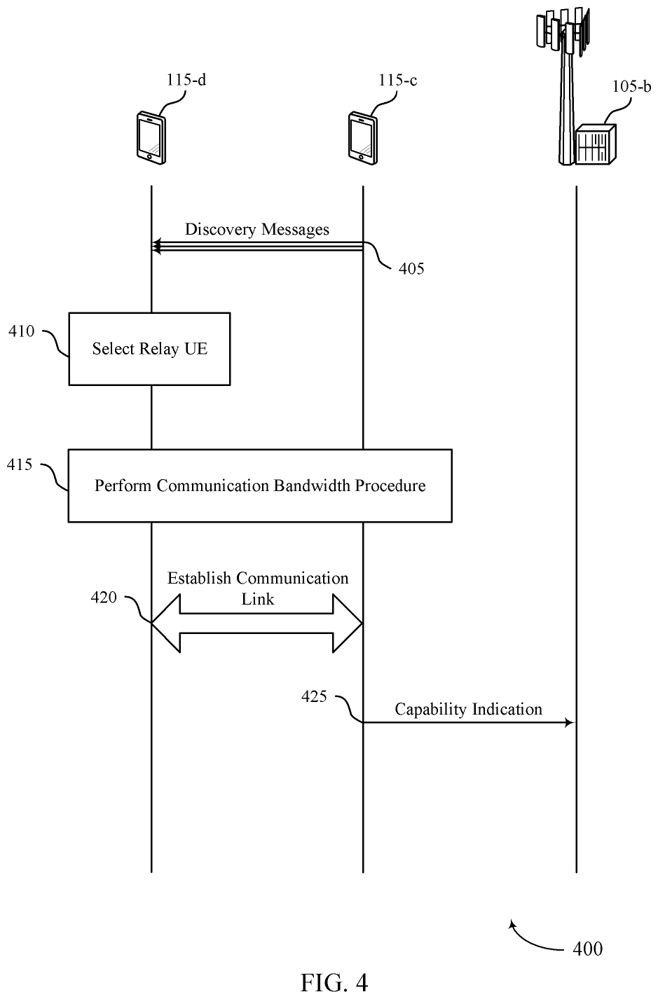

FIG. 4 illustrates an example of a process flow 400 that supports remote UE discovery and link establishment for reduced capability UE in accordance with aspects of the present disclosure. In some examples, the process flow 400 may implement aspects of wireless communications systems 100 or 200. For example, process flow 400 may include UE 115-c, UE 115-d, and base station 105-b, which may be examples of corresponding devices as described with reference to FIGS. 1 and 2. In some examples, the UE 115-c and the UE 115-d may exchange signaling with one another supporting discovery of and link establishment with the UE 115-d which may be an example of a reduced capability remote UE 115-d as described herein.

In the following description of the process flow 400, the operations may be performed (e.g., reported or provided) in a different order than the order shown, or the operations performed by the UE 115-c, the UE 115-d, and the base station 105-b may be performed in different orders or at different times. For example, specific operations also may be left out of the process flow 400, or other operations may be added to the process flow 400. Further, although some operations or signaling may be shown to occur at different times for discussion purposes, these operations may actually occur at the same time.

In some examples, the UE 115-d may be configured with one or more reduced capabilities relative to the UE 115-c, where the one or more reduced capabilities comprise a limitation on a maximum number of DRBs, a lack of support for carrier aggregation, a lack of support for dual connectivity, a limitation on a number of supported receiver chains, or a combination thereof.

At 405, the UE 115-c may transmit one or more discovery messages associated with establishing a sidelink relay communication link between the UE 115-c and the UE 115-d having a reduced communication bandwidth capability relative to the UE 115-c. In some examples, transmitting the one or more discovery messages includes transmitting the one or more discovery messages with broadcast signaling in a resource pool corresponding to the reduced communication bandwidth. In some examples, transmitting the one or more discovery messages includes transmitting the one or more discovery messages with broadcast signaling in a resource pool corresponding to a full communication bandwidth allocated for the UE 115-c (e.g., allocated by the base station 105-b, autonomously determined by the UE 115-c). In yet other examples, transmitting the one or more discovery messages includes transmitting a first set of discovery messages with broadcast signaling in a first resource pool corresponding to the full communication bandwidth allocated for the UE 115-c and transmitting a second set of discovery messages with broadcast signaling in a second resource pool corresponding to the reduced communication bandwidth. Additionally or alternatively, the one or more discovery messages may include a cell barring indication in the one or more discovery messages, the cell barring indication indicating one or more receiving chains for the UE 115-d. In some examples, the one or more discovery messages may include a first indication of whether the UE 115-c supports the reduced communication bandwidth, the full communication bandwidth, or both for a connection with the base station 105-b, a second indication of whether the UE 115-c supports the reduced communication bandwidth, the full communication bandwidth, or both for a sidelink connection, or a combination of the first indication and the second indication.

At 410, the UE 115-d may select a relay UE. For example, the UE 115-d may select the UE 115-c for establishing the sidelink relay communication link based on the UE 115-c supporting the reduced communication bandwidth for a sidelink communication, the UE 115-c supporting the reduced communication bandwidth for a communication link with the base station 105-b, or a combination thereof. In some examples, the UE 115-d may select the UE 115-c based on a priority associated with the UE 115-c supporting the reduced communication bandwidth for the sidelink communication or the UE 115-c supporting the reduced communication bandwidth for the communication link with the base station 105-b.

At 415, the UE 115-c may perform a communication bandwidth configuration procedure with the UE 115-d based at least in part on the UE 115-d having the reduced communication bandwidth capability relative to the UE 115-c.

At 420, the UE 115-c and the UE 115-d may establish a communication link. For example, the UE 115-c and the UE 115-d may establish, in accordance with the communication bandwidth configuration procedure, the sidelink relay communication link between the UE 115-c and the UE 115-d using the reduced communication bandwidth that is less than the full communication bandwidth allocated for the UE 115-c. In some examples, the sidelink relay communication link may be a PC5 communication link.

At 425, the UE 115-c may transmit a capability indication to the base station 105-b. For example, the UE 115-c may transmit an indication, to the base station 105-b, indicating that the UE 115-d has the reduced communication bandwidth capability relative to the UE 115-c. In some examples, the UE 115-c may transmit the indication via a dedicated RRC message while the UE 115-c is in an RRC connected state with the base station 105-b. In other examples, the UE 115-c may transmit the indication without transitioning to an RRC connected state while the UE 115-c is in an RRC idle state or an RRC inactive state with the base station 105-b. In such examples, the UE 115-c may transmit the indication via a dedicated LCID that may be configured for indicating that the UE 115-d has the reduced communication bandwidth capability relative to the UE 115-c or via an RRC message associated with the UE 115-c establishing or resuming a communication link with the base station 105-b.

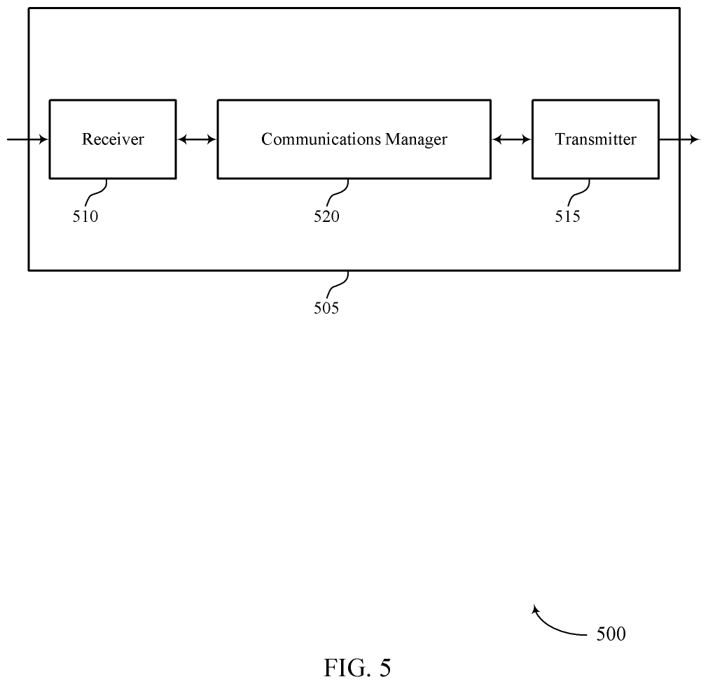

FIG. 5 shows a block diagram 500 of a device 505 that supports remote UE discovery and link establishment for reduced capability UE in accordance with aspects of the present disclosure. The device 505 may be an example of aspects of a relay UE as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to remote UE discovery and link establishment for reduced capability UE). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to remote UE discovery and link establishment for reduced capability UE). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of remote UE discovery and link establishment for reduced capability UE as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 520 may be configured to perform various operations (e.g., receiving, monitoring, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to receive information, transmit information, or perform various other operations as described herein.

The communications manager 520 may support wireless communication at a relay UE in accordance with examples as disclosed herein. For example, the communications manager 520 may be configured as or otherwise support a means for transmitting one or more discovery messages associated with establishing a sidelink relay communication link between the relay UE and a remote UE having a reduced communication bandwidth capability relative to the relay UE. The communications manager 520 may be configured as or otherwise support a means for performing a communication bandwidth configuration procedure with the remote UE based on the remote UE having the reduced communication bandwidth capability relative to the relay UE. The communications manager 520 may be configured as or otherwise support a means for establishing, in accordance with the communication bandwidth configuration procedure, the sidelink relay communication link between the relay UE and the remote UE using a reduced communication bandwidth that is less than a full communication bandwidth allocated for the relay UE.

By including or configuring the communications manager 520 in accordance with examples as described herein, the device 505 (e.g., a processor controlling or otherwise coupled to the receiver 510, the transmitter 515, the communications manager 520, or a combination thereof) may support techniques for discovery messages and link establishment considering reduced capabilities for UEs, resulting in reduced processing, reduced power consumption, and more efficient utilization of communication resources.

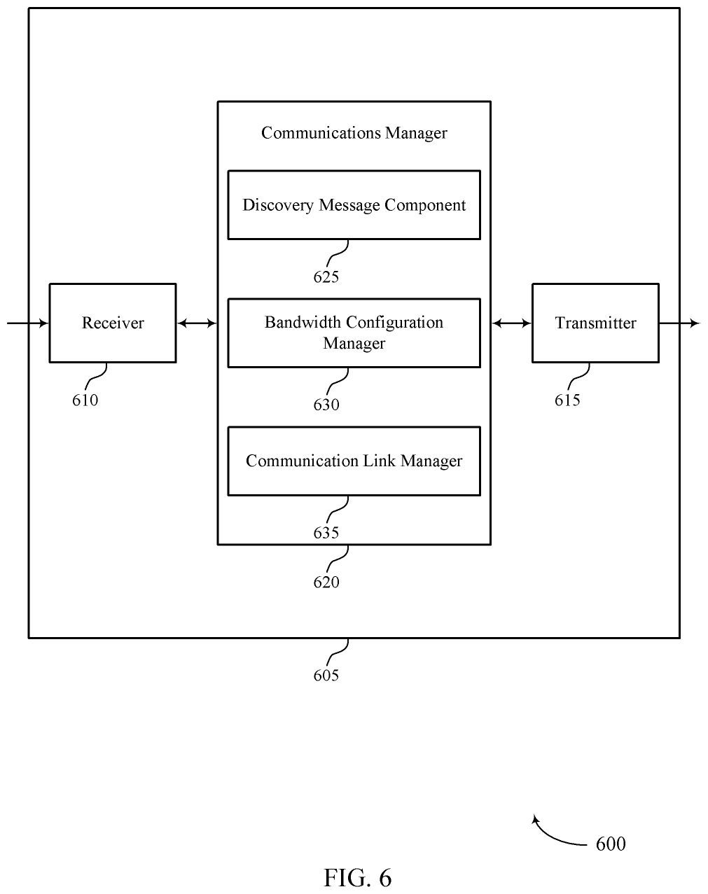

FIG. 6 shows a block diagram 600 of a device 605 that supports remote UE discovery and link establishment for reduced capability UE in accordance with aspects of the present disclosure. The device 605 may be an example of aspects of a device 505 or a relay UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to remote UE discovery and link establishment for reduced capability UE). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to remote UE discovery and link establishment for reduced capability UE). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of remote UE discovery and link establishment for reduced capability UE as described herein. For example, the communications manager 620 may include a discovery message component 625, a bandwidth configuration manager 630, a communication link manager 635, or any combination thereof. The communications manager 620 may be an example of aspects of a communications manager 520 as described herein. In some examples, the communications manager 620, or various components thereof, may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communication at a relay UE in accordance with examples as disclosed herein. The discovery message component 625 may be configured as or otherwise support a means for transmitting one or more discovery messages associated with establishing a sidelink relay communication link between the relay UE and a remote UE having a reduced communication bandwidth capability relative to the relay UE. The bandwidth configuration manager 630 may be configured as or otherwise support a means for performing a communication bandwidth configuration procedure with the remote UE based on the remote UE having the reduced communication bandwidth capability relative to the relay UE. The communication link manager 635 may be configured as or otherwise support a means for establishing, in accordance with the communication bandwidth configuration procedure, the sidelink relay communication link between the relay UE and the remote UE using a reduced communication bandwidth that is less than a full communication bandwidth allocated for the relay UE.

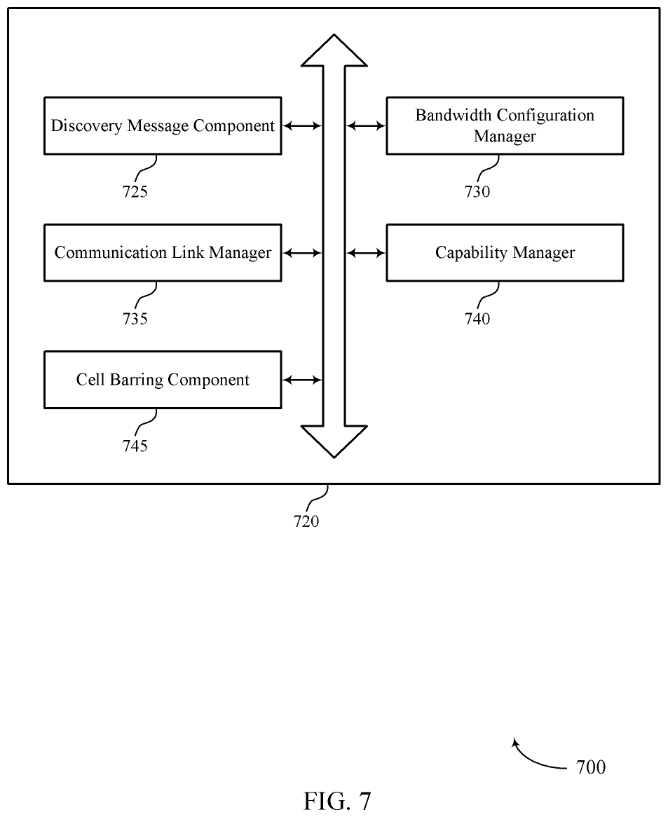

FIG. 7 shows a block diagram 700 of a communications manager 720 that supports remote UE discovery and link establishment for reduced capability UE in accordance with aspects of the present disclosure. The communications manager 720 may be an example of aspects of a communications manager 520, a communications manager 620, or both, as described herein. The communications manager 720, or various components thereof, may be an example of means for performing various aspects of remote UE discovery and link establishment for reduced capability UE as described herein. For example, the communications manager 720 may include a discovery message component 725, a bandwidth configuration manager 730, a communication link manager 735, a capability manager 740, a cell barring component 745, or any combination thereof. Each of these components may communicate, directly or indirectly, with one another (e.g., via one or more buses).

The communications manager 720 may support wireless communication at a relay UE in accordance with examples as disclosed herein. The discovery message component 725 may be configured as or otherwise support a means for transmitting one or more discovery messages associated with establishing a sidelink relay communication link between the relay UE and a remote UE having a reduced communication bandwidth capability relative to the relay UE. The bandwidth configuration manager 730 may be configured as or otherwise support a means for performing a communication bandwidth configuration procedure with the remote UE based on the remote UE having the reduced communication bandwidth capability relative to the relay UE. The communication link manager 735 may be configured as or otherwise support a means for establishing, in accordance with the communication bandwidth configuration procedure, the sidelink relay communication link between the relay UE and the remote UE using a reduced communication bandwidth that is less than a full communication bandwidth allocated for the relay UE.

In some examples, to support transmitting the one or more discovery messages, the discovery message component 725 may be configured as or otherwise support a means for transmitting the one or more discovery messages with broadcast signaling in a resource pool corresponding to the reduced communication bandwidth.

In some examples, to support transmitting the one or more discovery messages, the discovery message component 725 may be configured as or otherwise support a means for transmitting the one or more discovery messages with broadcast signaling in a resource pool corresponding to the full communication bandwidth allocated for the relay UE.

In some examples, to support transmitting the one or more discovery messages, the discovery message component 725 may be configured as or otherwise support a means for transmitting a first set of discovery messages with broadcast signaling in a first resource pool corresponding to the full communication bandwidth allocated for the relay UE. In some examples, to support transmitting the one or more discovery messages, the discovery message component 725 may be configured as or otherwise support a means for transmitting a second set of discovery messages with broadcast signaling in a second resource pool corresponding to the reduced communication bandwidth.

In some examples, the capability manager 740 may be configured as or otherwise support a means for transmitting an indication, to a base station, indicating that the remote UE has the reduced communication bandwidth capability relative to the relay UE.

In some examples, to support transmitting the indication, the capability manager 740 may be configured as or otherwise support a means for transmitting the indication via a dedicated RRC message while the relay UE is in an RRC connected state with the base station.

In some examples, to support transmitting the indication, the capability manager 740 may be configured as or otherwise support a means for transmitting the indication without transitioning to an RRC connected state while the relay UE is in an RRC idle state or an RRC inactive state with the base station.

In some examples, to support transmitting the indication, the capability manager 740 may be configured as or otherwise support a means for transmitting the indication via a dedicated LCID that is configured for indicating that the remote UE has the reduced communication bandwidth capability relative to the relay UE.

In some examples, to support transmitting the indication, the capability manager 740 may be configured as or otherwise support a means for transmitting the indication via an RRC message associated with the relay UE establishing or resuming a communication link with the base station.

In some examples, to support transmitting the one or more discovery messages, the cell barring component 745 may be configured as or otherwise support a means for transmitting a cell barring indication in the one or more discovery messages, the cell barring indication indicating one or more receiving chains for the remote UE.

In some examples, the remote UE is configured with one or more reduced capabilities relative to the relay UE. In some examples, the one or more reduced capabilities include a limitation on a maximum number of DRBs, a lack of support for carrier aggregation, a lack of support for dual connectivity, a limitation on a number of supported receiver chains, or a combination thereof. In some examples, the sidelink relay communication link is a PC5 communication link.

In some examples, the one or more discovery messages includes a first indication of whether the relay UE supports the reduced communication bandwidth, the full communication bandwidth, or both for a connection with a base station, a second indication of whether the relay UE supports the reduced communication bandwidth, the full communication bandwidth, or both for a sidelink connection, or a combination of the first indication and the second indication.

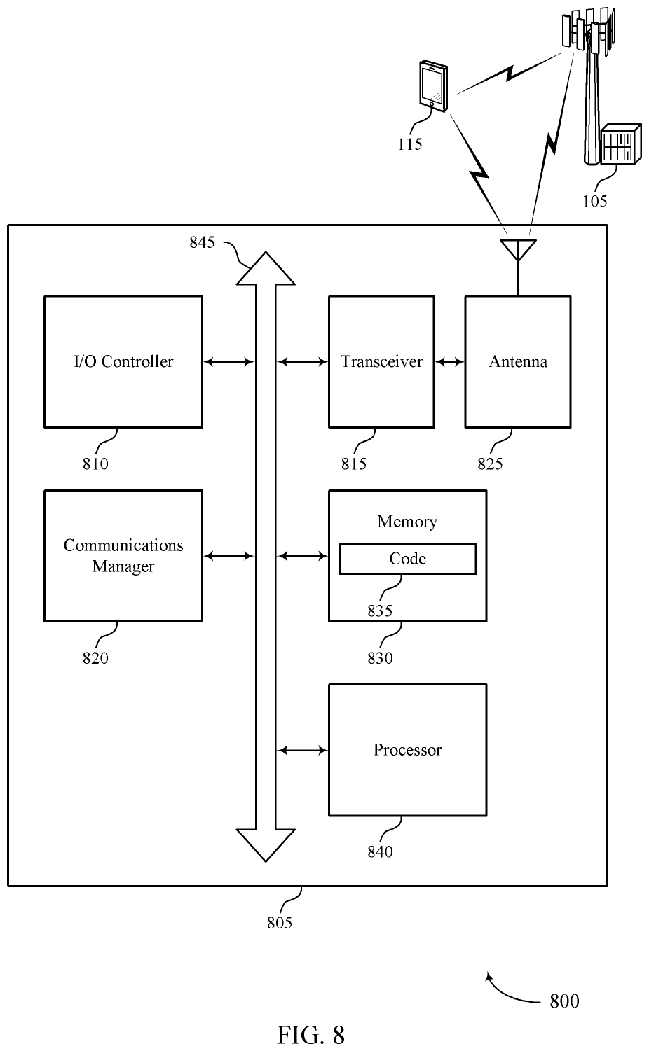

FIG. 8 shows a diagram of a system 800 including a device 805 that supports remote UE discovery and link establishment for reduced capability UE in accordance with aspects of the present disclosure. The device 805 may be an example of or include the components of a device 505, a device 605, or a relay UE as described herein. The device 805 may include components for bi-directional voice and data communications including components for transmitting and receiving communications, such as a communications manager 820, an I/O controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include RAM and ROM. The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a BIOS which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting remote UE discovery and link establishment for reduced capability UE). For example, the device 805 or a component of the device 805 may include a processor 840 and memory 830 coupled with or to the processor 840, the processor 840 and memory 830 configured to perform various functions described herein.

The communications manager 820 may support wireless communication at a relay UE in accordance with examples as disclosed herein. For example, the communications manager 820 may be configured as or otherwise support a means for transmitting one or more discovery messages associated with establishing a sidelink relay communication link between the relay UE and a remote UE having a reduced communication bandwidth capability relative to the relay UE. The communications manager 820 may be configured as or otherwise support a means for performing a communication bandwidth configuration procedure with the remote UE based on the remote UE having the reduced communication bandwidth capability relative to the relay UE. The communications manager 820 may be configured as or otherwise support a means for establishing, in accordance with the communication bandwidth configuration procedure, the sidelink relay communication link between the relay UE and the remote UE using a reduced communication bandwidth that is less than a full communication bandwidth allocated for the relay UE.

By including or configuring the communications manager 820 in accordance with examples as described herein, the device 805 may support techniques for discovery messages and link establishment considering reduced capabilities for UEs, resulting in improved communication reliability, reduced latency, more efficient utilization of communication resources, improved coordination between devices, and improved utilization of processing capability.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of remote UE discovery and link establishment for reduced capability UE as described herein, or the processor 840 and the memory 830 may be otherwise configured to perform or support such operations.

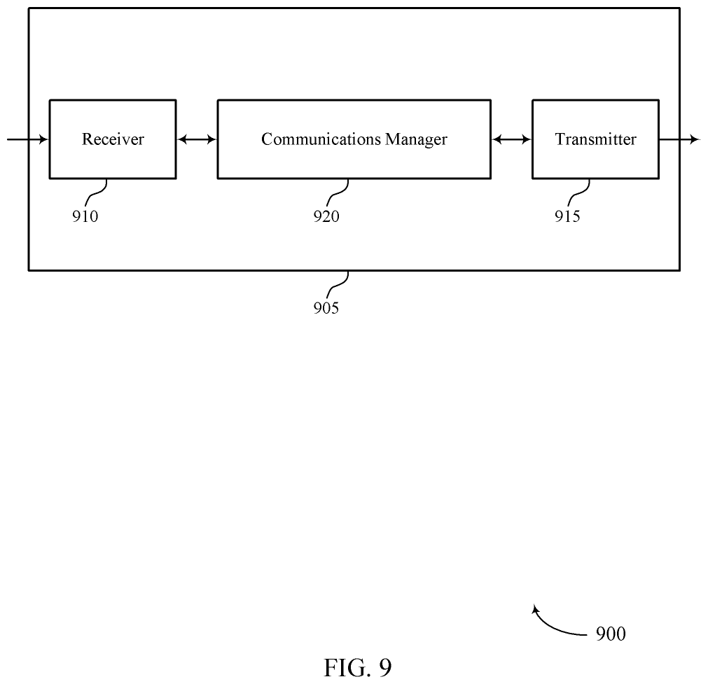

FIG. 9 shows a block diagram 900 of a device 905 that supports remote UE discovery and link establishment for reduced capability UE in accordance with aspects of the present disclosure. The device 905 may be an example of aspects of a remote UE as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to remote UE discovery and link establishment for reduced capability UE). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to remote UE discovery and link establishment for reduced capability UE). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations thereof or various components thereof may be examples of means for performing various aspects of remote UE discovery and link establishment for reduced capability UE as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 920 may be configured to perform various operations (e.g., receiving, monitoring, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to receive information, transmit information, or perform various other operations as described herein.

The communications manager 920 may support wireless communication at a remote UE in accordance with examples as disclosed herein. For example, the communications manager 920 may be configured as or otherwise support a means for receiving one or more discovery messages associated with establishing a sidelink relay communication link between a relay UE and the remote UE, where the remote UE has a reduced communication bandwidth capability relative to the relay UE. The communications manager 920 may be configured as or otherwise support a means for performing a communication bandwidth configuration procedure with the relay UE based on the remote UE having the reduced communication bandwidth capability relative to the relay UE. The communications manager 920 may be configured as or otherwise support a means for establishing, in accordance with the communication bandwidth configuration procedure, the sidelink relay communication link between the relay UE and the remote UE using a reduced communication bandwidth that is less than a full communication bandwidth allocated for the relay UE.

By including or configuring the communications manager 920 in accordance with examples as described herein, the device 905 (e.g., a processor controlling or otherwise coupled to the receiver 910, the transmitter 915, the communications manager 920, or a combination thereof) may support techniques for discovery messages and link establishment considering reduced capabilities for UEs, resulting in reduced processing, reduced power consumption, and more efficient utilization of communication resources.

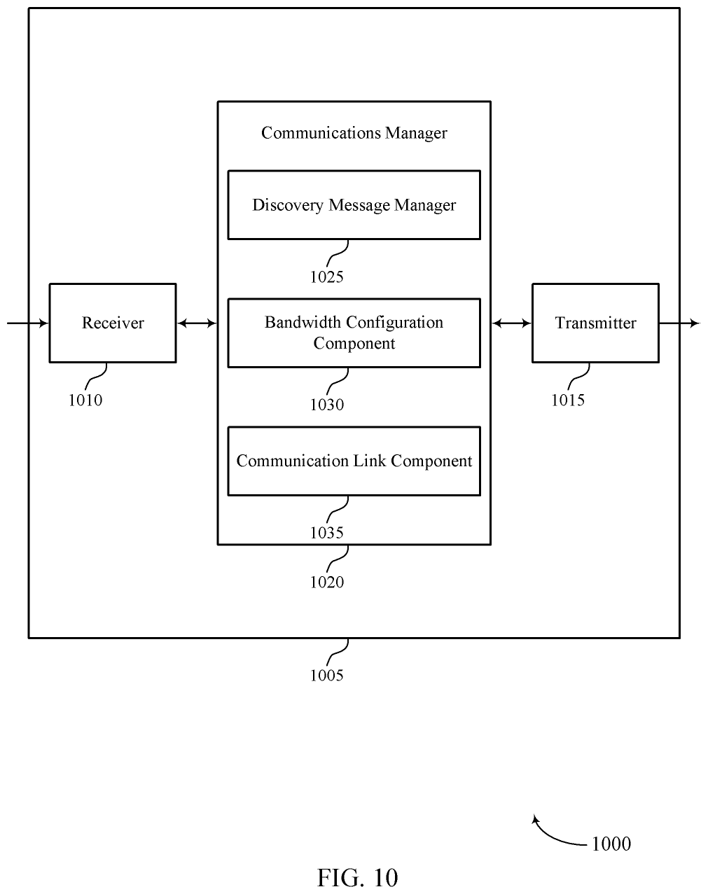

FIG. 10 shows a block diagram 1000 of a device 1005 that supports remote UE discovery and link establishment for reduced capability UE in accordance with aspects of the present disclosure. The device 1005 may be an example of aspects of a device 905 or a remote UE 115 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to remote UE discovery and link establishment for reduced capability UE). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to remote UE discovery and link establishment for reduced capability UE). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of remote UE discovery and link establishment for reduced capability UE as described herein. For example, the communications manager 1020 may include a discovery message manager 1025, a bandwidth configuration component 1030, a communication link component 1035, or any combination thereof. The communications manager 1020 may be an example of aspects of a communications manager 920 as described herein. In some examples, the communications manager 1020, or various components thereof, may be configured to perform various operations (e.g., receiving, monitoring, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to receive information, transmit information, or perform various other operations as described herein.

The communications manager 1020 may support wireless communication at a remote UE in accordance with examples as disclosed herein. The discovery message manager 1025 may be configured as or otherwise support a means for receiving one or more discovery messages associated with establishing a sidelink relay communication link between a relay UE and the remote UE, where the remote UE has a reduced communication bandwidth capability relative to the relay UE. The bandwidth configuration component 1030 may be configured as or otherwise support a means for performing a communication bandwidth configuration procedure with the relay UE based on the remote UE having the reduced communication bandwidth capability relative to the relay UE. The communication link component 1035 may be configured as or otherwise support a means for establishing, in accordance with the communication bandwidth configuration procedure, the sidelink relay communication link between the relay UE and the remote UE using a reduced communication bandwidth that is less than a full communication bandwidth allocated for the relay UE.

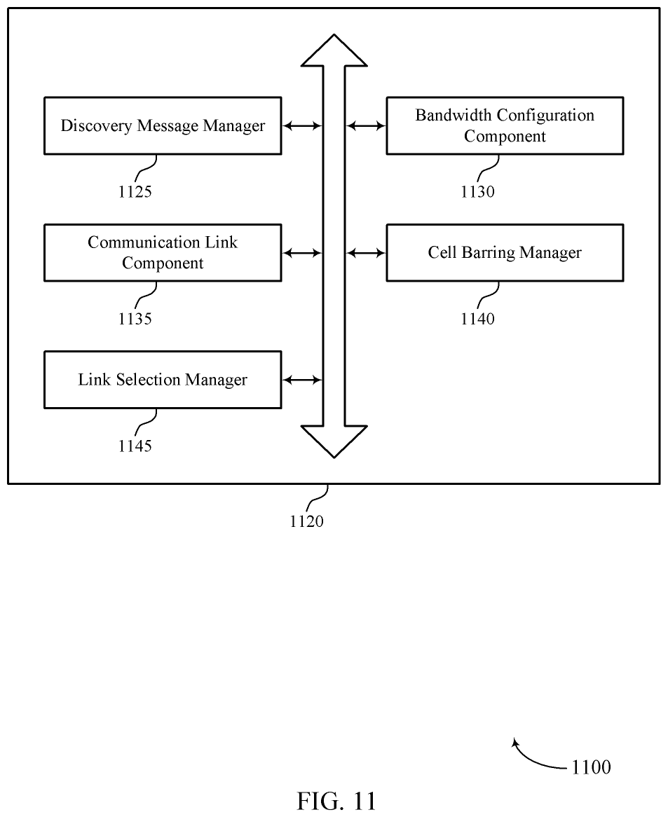

FIG. 11 shows a block diagram 1100 of a communications manager 1120 that supports remote UE discovery and link establishment for reduced capability UE in accordance with aspects of the present disclosure. The communications manager 1120 may be an example of aspects of a communications manager 920, a communications manager 1020, or both, as described herein. The communications manager 1120, or various components thereof, may be an example of means for performing various aspects of remote UE discovery and link establishment for reduced capability UE as described herein. For example, the communications manager 1120 may include a discovery message manager 1125, a bandwidth configuration component 1130, a communication link component 1135, a cell barring manager 1140, a link selection manager 1145, or any combination thereof. Each of these components may communicate, directly or indirectly, with one another (e.g., via one or more buses).

The communications manager 1120 may support wireless communication at a remote UE in accordance with examples as disclosed herein. The discovery message manager 1125 may be configured as or otherwise support a means for receiving one or more discovery messages associated with establishing a sidelink relay communication link between a relay UE and the remote UE, where the remote UE has a reduced communication bandwidth capability relative to the relay UE. The bandwidth configuration component 1130 may be configured as or otherwise support a means for performing a communication bandwidth configuration procedure with the relay UE based on the remote UE having the reduced communication bandwidth capability relative to the relay UE. The communication link component 1135 may be configured as or otherwise support a means for establishing, in accordance with the communication bandwidth configuration procedure, the sidelink relay communication link between the relay UE and the remote UE using a reduced communication bandwidth that is less than a full communication bandwidth allocated for the relay UE.

In some examples, to support receiving the one or more discovery messages, the discovery message manager 1125 may be configured as or otherwise support a means for receiving the one or more discovery messages over broadcast signaling in a resource pool corresponding to the reduced communication bandwidth.

In some examples, to support receiving the one or more discovery messages, the discovery message manager 1125 may be configured as or otherwise support a means for receiving the one or more discovery messages over broadcast signaling in a resource pool corresponding to the full communication bandwidth allocated for the relay UE.

In some examples, to support receiving the one or more discovery messages, the discovery message manager 1125 may be configured as or otherwise support a means for receiving a first set of discovery messages over broadcast signaling in a first resource pool corresponding to the full communication bandwidth allocated for the relay UE. In some examples, to support receiving the one or more discovery messages, the discovery message manager 1125 may be configured as or otherwise support a means for receiving a second set of discovery messages over broadcast signaling in a second resource pool corresponding to the reduced communication bandwidth.

In some examples, to support receiving the one or more discovery messages, the cell barring manager 1140 may be configured as or otherwise support a means for receiving a cell barring indication in the one or more discovery messages, the cell barring indication indicating one or more receiving chains for the remote UE.

In some examples, the link selection manager 1145 may be configured as or otherwise support a means for selecting the relay UE for establishing the sidelink relay communication link based on the relay UE supporting the reduced communication bandwidth for a sidelink communication, the relay UE supporting the reduced communication bandwidth for a communication link with a base station, or a combination thereof.

In some examples, to support selecting the relay UE, the link selection manager 1145 may be configured as or otherwise support a means for selecting the relay UE based on a priority associated with the relay UE supporting the reduced communication bandwidth for the sidelink communication or the relay UE supporting the reduced communication bandwidth for the communication link with the base station.

In some examples, the remote UE is configured with one or more reduced capabilities relative to the relay UE. In some examples, the one or more reduced capabilities include a limitation on a maximum number of DRBs, a lack of support for carrier aggregation, a lack of support for dual connectivity, a limitation on a number of supported receiver chains, or a combination thereof. In some examples, the sidelink relay communication link is a PC5 communication link.

In some examples, the one or more discovery messages includes a first indication of whether the relay UE supports the reduced communication bandwidth, the full communication bandwidth, or both for a connection with a base station, a second indication of whether the relay UE supports the reduced communication bandwidth, the full communication bandwidth, or both for a sidelink connection, or a combination of the first indication and the second indication.

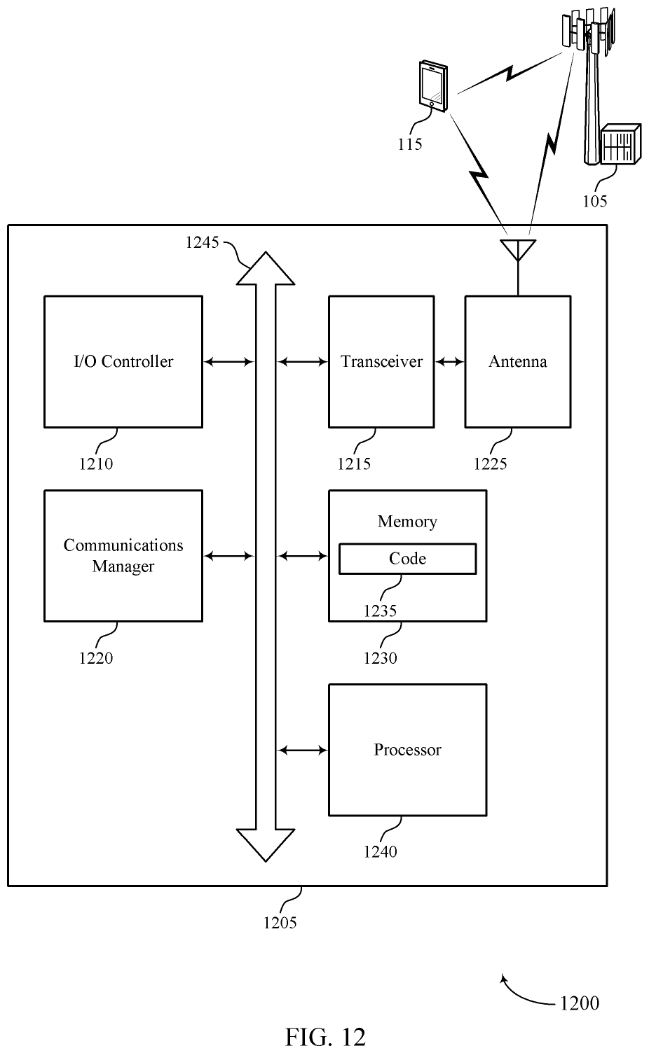

FIG. 12 shows a diagram of a system 1200 including a device 1205 that supports remote UE discovery and link establishment for reduced capability UE in accordance with aspects of the present disclosure. The device 1205 may be an example of or include the components of a device 905, a device 1005, or a remote UE as described herein. The device 1205 may include components for bi-directional voice and data communications including components for transmitting and receiving communications, such as a communications manager 1220, a transceiver 1215, an antenna 1225, a memory 1230, code 1235, a processor 1240, and an I/O controller 1210. These components may be in electronic communication or otherwise coupled (e.g., operatively, communicatively, functionally, electronically, electrically) via one or more buses (e.g., a bus 1245).

In some cases, the device 1205 may include a single antenna 1225. However, in some other cases, the device 1205 may have more than one antenna 1225, which may be capable of concurrently transmitting or receiving multiple wireless transmissions. The transceiver 1215 may communicate bi-directionally, via the one or more antennas 1225, wired, or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The memory 1230 may include RAM and ROM. The memory 1230 may store computer-readable, computer-executable code 1235 including instructions that, when executed by the processor 1240, cause the device 1205 to perform various functions described herein. The code 1235 may be stored in a non-transitory computer-readable medium such as system memory or another type of memory. In some cases, the code 1235 may not be directly executable by the processor 1240 but may cause a computer (e.g., when compiled and executed) to perform functions described herein. In some cases, the memory 1230 may contain, among other things, a BIOS which may control basic hardware or software operation such as the interaction with peripheral components or devices.

The processor 1240 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some other cases, a memory controller may be integrated into the processor 1240. The processor 1240 may be configured to execute computer-readable instructions stored in a memory (e.g., the memory 1230) to cause the device 1205 to perform various functions (e.g., functions or tasks supporting remote UE discovery and link establishment for reduced capability UE). For example, the device 1205 or a component of the device 1205 may include a processor 1240 and memory 1230 coupled with or to the processor 1240, the processor 1240 and memory 1230 configured to perform various functions described herein.

The communications manager 1220 may support wireless communication at a remote UE in accordance with examples as disclosed herein. For example, the communications manager 1220 may be configured as or otherwise support a means for receiving one or more discovery messages associated with establishing a sidelink relay communication link between a relay UE and the remote UE, where the remote UE has a reduced communication bandwidth capability relative to the relay UE. The communications manager 1220 may be configured as or otherwise support a means for performing a communication bandwidth configuration procedure with the relay UE based on the remote UE having the reduced communication bandwidth capability relative to the relay UE. The communications manager 1220 may be configured as or otherwise support a means for establishing, in accordance with the communication bandwidth configuration procedure, the sidelink relay communication link between the relay UE and the remote UE using a reduced communication bandwidth that is less than a full communication bandwidth allocated for the relay UE.

By including or configuring the communications manager 1220 in accordance with examples as described herein, the device 1205 may support techniques for discovery messages and link establishment considering reduced capabilities for UEs, resulting in improved communication reliability, reduced latency, more efficient utilization of communication resources, improved coordination between devices, and improved utilization of processing capability.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the processor 1240, the memory 1230, the code 1235, or any combination thereof. For example, the code 1235 may include instructions executable by the processor 1240 to cause the device 1205 to perform various aspects of remote UE discovery and link establishment for reduced capability UE as described herein, or the processor 1240 and the memory 1230 may be otherwise configured to perform or support such operations.

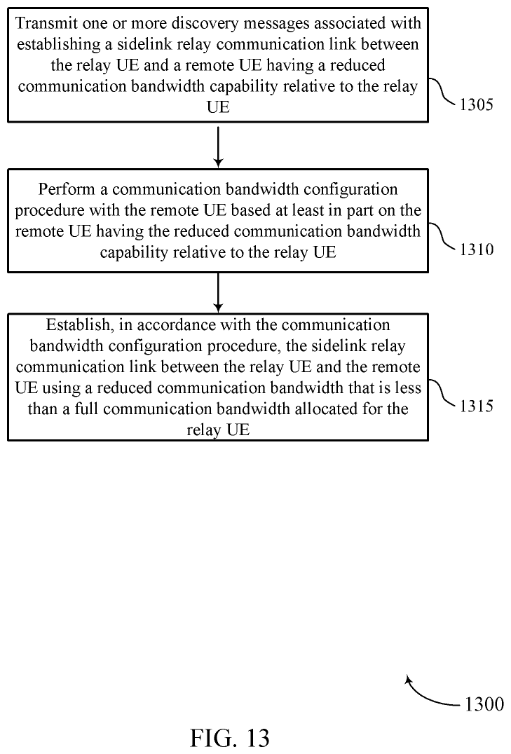

FIG. 13 shows a flowchart illustrating a method 1300 that supports remote UE discovery and link establishment for reduced capability UE in accordance with aspects of the present disclosure. The operations of the method 1300 may be implemented by a relay UE or its components as described herein. For example, the operations of the method 1300 may be performed by a relay UE as described with reference to FIGS. 1 through 8. In some examples, a relay UE may execute a set of instructions to control the functional elements of the relay UE to perform the described functions. Additionally or alternatively, the relay UE may perform aspects of the described functions using special-purpose hardware.

At 1305, the method may include transmitting one or more discovery messages associated with establishing a sidelink relay communication link between the relay UE and a remote UE having a reduced communication bandwidth capability relative to the relay UE. The operations of 1305 may be performed in accordance with examples as disclosed herein. In some examples, aspects of the operations of 1305 may be performed by a discovery message component 725 as described with reference to FIG. 7.

At 1310, the method may include performing a communication bandwidth configuration procedure with the remote UE based on the remote UE having the reduced communication bandwidth capability relative to the relay UE. The operations of 1310 may be performed in accordance with examples as disclosed herein. In some examples, aspects of the operations of 1310 may be performed by a bandwidth configuration manager 730 as described with reference to FIG. 7.

At 1315, the method may include establishing, in accordance with the communication bandwidth configuration procedure, the sidelink relay communication link between the relay UE and the remote UE using a reduced communication bandwidth that is less than a full communication bandwidth allocated for the relay UE. The operations of 1315 may be performed in accordance with examples as disclosed herein. In some examples, aspects of the operations of 1315 may be performed by a communication link manager 735 as described with reference to FIG. 7.

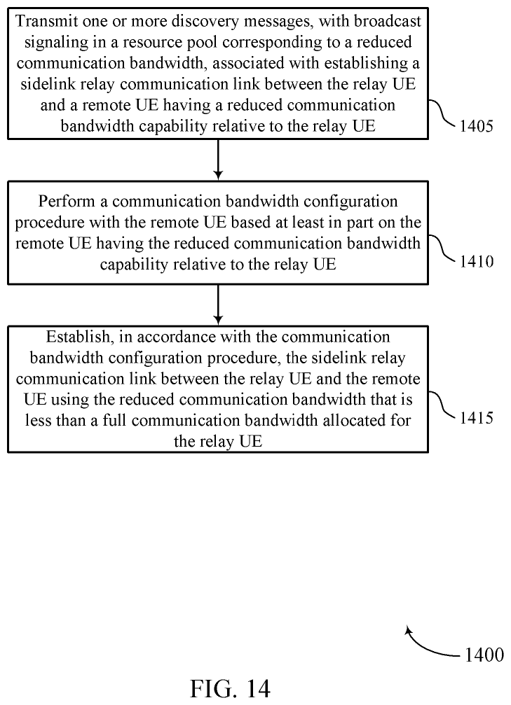

FIG. 14 shows a flowchart illustrating a method 1400 that supports remote UE discovery and link establishment for reduced capability UE in accordance with aspects of the present disclosure. The operations of the method 1400 may be implemented by a relay UE or its components as described herein. For example, the operations of the method 1400 may be performed by a relay UE as described with reference to FIGS. 1 through 8. In some examples, a relay UE may execute a set of instructions to control the functional elements of the relay UE to perform the described functions. Additionally or alternatively, the relay UE may perform aspects of the described functions using special-purpose hardware.

At 1405, the method may include transmitting one or more discovery messages, with broadcast signaling in a resource pool corresponding to a reduced communication bandwidth, associated with establishing a sidelink relay communication link between the relay UE and a remote UE having a reduced communication bandwidth capability relative to the relay UE. The operations of 1405 may be performed in accordance with examples as disclosed herein. In some examples, aspects of the operations of 1405 may be performed by a discovery message component 725 as described with reference to FIG. 7.

At 1410, the method may include performing a communication bandwidth configuration procedure with the remote UE based on the remote UE having the reduced communication bandwidth capability relative to the relay UE. The operations of 1410 may be performed in accordance with examples as disclosed herein. In some examples, aspects of the operations of 1410 may be performed by a bandwidth configuration manager 730 as described with reference to FIG. 7.

At 1415, the method may include establishing, in accordance with the communication bandwidth configuration procedure, the sidelink relay communication link between the relay UE and the remote UE using a reduced communication bandwidth that is less than a full communication bandwidth allocated for the relay UE. The operations of 1415 may be performed in accordance with examples as disclosed herein. In some examples, aspects of the operations of 1415 may be performed by a communication link manager 735 as described with reference to FIG. 7.

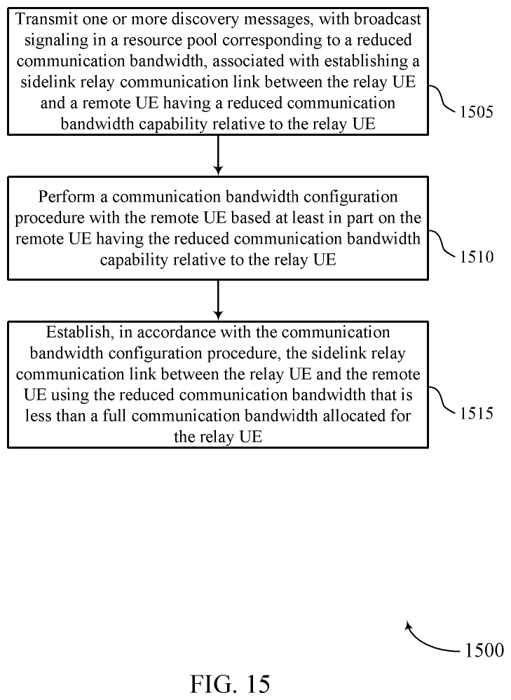

FIG. 15 shows a flowchart illustrating a method 1500 that supports remote UE discovery and link establishment for reduced capability UE in accordance with aspects of the present disclosure. The operations of the method 1500 may be implemented by a relay UE or its components as described herein. For example, the operations of the method 1500 may be performed by a relay UE as described with reference to FIGS. 1 through 8. In some examples, a relay UE may execute a set of instructions to control the functional elements of the relay UE to perform the described functions. Additionally or alternatively, the relay UE may perform aspects of the described functions using special-purpose hardware.

At 1505, the method may include transmitting one or more discovery messages, with broadcast signaling in a resource pool corresponding to a reduced communication bandwidth, associated with establishing a sidelink relay communication link between the relay UE and a remote UE having a reduced communication bandwidth capability relative to the relay UE. The operations of 1505 may be performed in accordance with examples as disclosed herein. In some examples, aspects of the operations of 1505 may be performed by a discovery message component 725 as described with reference to FIG. 7.

At 1510, the method may include performing a communication bandwidth configuration procedure with the remote UE based on the remote UE having the reduced communication bandwidth capability relative to the relay UE. The operations of 1510 may be performed in accordance with examples as disclosed herein. In some examples, aspects of the operations of 1510 may be performed by a bandwidth configuration manager 730 as described with reference to FIG. 7.

At 1515, the method may include establishing, in accordance with the communication bandwidth configuration procedure, the sidelink relay communication link between the relay UE and the remote UE using a reduced communication bandwidth that is less than a full communication bandwidth allocated for the relay UE. The operations of 1515 may be performed in accordance with examples as disclosed herein. In some examples, aspects of the operations of 1515 may be performed by a communication link manager 735 as described with reference to FIG. 7.

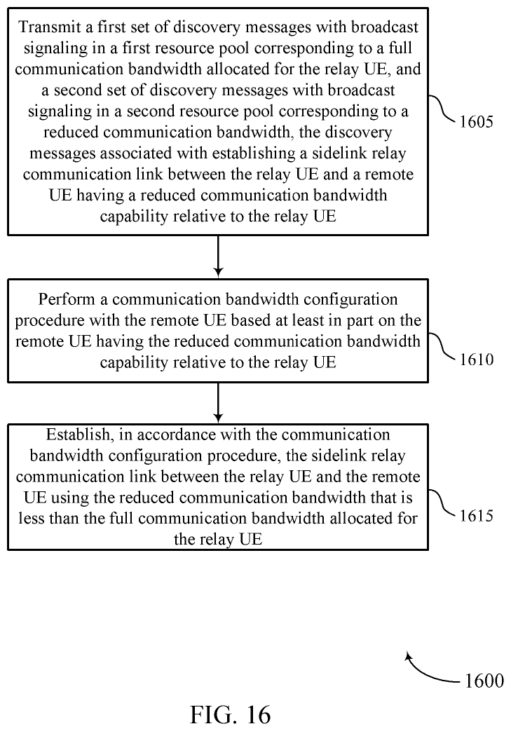

FIG. 16 shows a flowchart illustrating a method 1600 that supports remote UE discovery and link establishment for reduced capability UE in accordance with aspects of the present disclosure. The operations of the method 1600 may be implemented by a relay UE or its components as described herein. For example, the operations of the method 1600 may be performed by a relay UE as described with reference to FIGS. 1 through 8. In some examples, a relay UE may execute a set of instructions to control the functional elements of the relay UE to perform the described functions. Additionally or alternatively, the relay UE may perform aspects of the described functions using special-purpose hardware.

At 1605, the method may include transmitting a first set of discovery messages with broadcast signaling in a first resource pool corresponding to a full communication bandwidth allocated for the relay UE, and a second set of discovery messages with broadcast signaling in a second resource pool corresponding to a reduced communication bandwidth, the discovery messages associated with establishing a sidelink relay communication link between the relay UE and a remote UE having a reduced communication bandwidth capability relative to the relay UE. The operations of 1605 may be performed in accordance with examples as disclosed herein. In some examples, aspects of the operations of 1605 may be performed by a discovery message component 725 as described with reference to FIG. 7.

At 1610, the method may include performing a communication bandwidth configuration procedure with the remote UE based on the remote UE having the reduced communication bandwidth capability relative to the relay UE. The operations of 1610 may be performed in accordance with examples as disclosed herein. In some examples, aspects of the operations of 1610 may be performed by a bandwidth configuration manager 730 as described with reference to FIG. 7.

At 1615, the method may include establishing, in accordance with the communication bandwidth configuration procedure, the sidelink relay communication link between the relay UE and the remote UE using a reduced communication bandwidth that is less than a full communication bandwidth allocated for the relay UE. The operations of 1615 may be performed in accordance with examples as disclosed herein. In some examples, aspects of the operations of 1615 may be performed by a communication link manager 735 as described with reference to FIG. 7.

At 1620, the method may include transmitting a first set of discovery messages with broadcast signaling in a first resource pool corresponding to the full communication bandwidth allocated for the relay UE. The operations of 1620 may be performed in accordance with examples as disclosed herein. In some examples, aspects of the operations of 1620 may be performed by a discovery message component 725 as described with reference to FIG. 7.

At 1625, the method may include transmitting a second set of discovery messages with broadcast signaling in a second resource pool corresponding to the reduced communication bandwidth. The operations of 1625 may be performed in accordance with examples as disclosed herein. In some examples, aspects of the operations of 1625 may be performed by a discovery message component 725 as described with reference to FIG. 7.

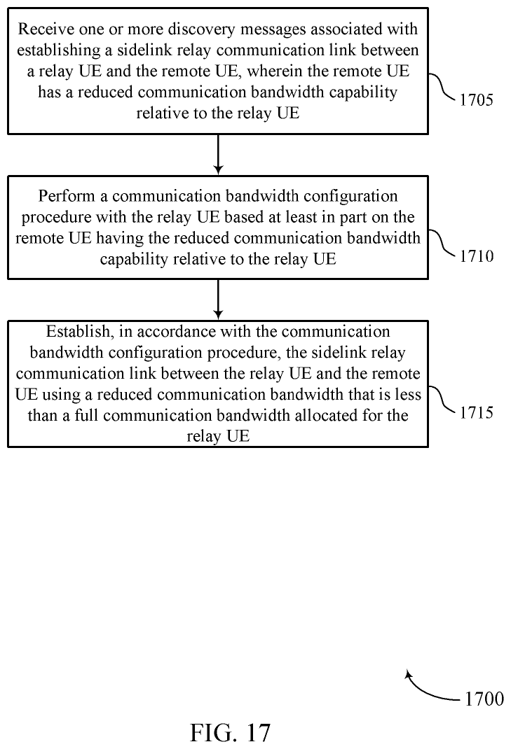

FIG. 17 shows a flowchart illustrating a method 1700 that supports remote UE discovery and link establishment for reduced capability UE in accordance with aspects of the present disclosure. The operations of the method 1700 may be implemented by a remote UE or its components as described herein. For example, the operations of the method 1700 may be performed by a remote UE as described with reference to FIGS. 1 through 4 and 9 through 12. In some examples, a remote UE may execute a set of instructions to control the functional elements of the remote UE to perform the described functions. Additionally or alternatively, the remote UE may perform aspects of the described functions using special-purpose hardware.

At 1705, the method may include receiving one or more discovery messages associated with establishing a sidelink relay communication link between a relay UE and the remote UE, where the remote UE has a reduced communication bandwidth capability relative to the relay UE. The operations of 1705 may be performed in accordance with examples as disclosed herein. In some examples, aspects of the operations of 1705 may be performed by a discovery message manager 1125 as described with reference to FIG. 11.

At 1710, the method may include performing a communication bandwidth configuration procedure with the relay UE based on the remote UE having the reduced communication bandwidth capability relative to the relay UE. The operations of 1710 may be performed in accordance with examples as disclosed herein. In some examples, aspects of the operations of 1710 may be performed by a bandwidth configuration component 1130 as described with reference to FIG. 11.

At 1715, the method may include establishing, in accordance with the communication bandwidth configuration procedure, the sidelink relay communication link between the relay UE and the remote UE using a reduced communication bandwidth that is less than a full communication bandwidth allocated for the relay UE. The operations of 1715 may be performed in accordance with examples as disclosed herein. In some examples, aspects of the operations of 1715 may be performed by a communication link component 1135 as described with reference to FIG. 11.

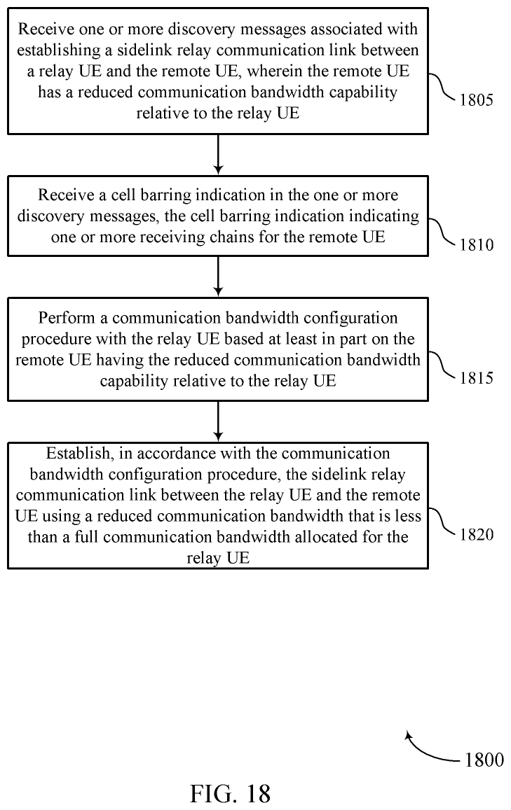

FIG. 18 shows a flowchart illustrating a method 1800 that supports remote UE discovery and link establishment for reduced capability UE in accordance with aspects of the present disclosure. The operations of the method 1800 may be implemented by a remote UE or its components as described herein. For example, the operations of the method 1800 may be performed by a remote UE as described with reference to FIGS. 1 through 4 and 9 through 12. In some examples, a remote UE may execute a set of instructions to control the functional elements of the remote UE to perform the described functions. Additionally or alternatively, the remote UE may perform aspects of the described functions using special-purpose hardware.

At 1805, the method may include receiving one or more discovery messages associated with establishing a sidelink relay communication link between a relay UE and the remote UE, where the remote UE has a reduced communication bandwidth capability relative to the relay UE. The operations of 1805 may be performed in accordance with examples as disclosed herein. In some examples, aspects of the operations of 1805 may be performed by a discovery message manager 1125 as described with reference to FIG. 11.

At 1810, the method may include receiving a cell barring indication in the one or more discovery messages, the cell barring indication indicating one or more receiving chains for the remote UE. The operations of 1810 may be performed in accordance with examples as disclosed herein. In some examples, aspects of the operations of 1810 may be performed by a cell barring manager 1140 as described with reference to FIG. 11.

At 1815, the method may include performing a communication bandwidth configuration procedure with the relay UE based on the remote UE having the reduced communication bandwidth capability relative to the relay UE. The operations of 1815 may be performed in accordance with examples as disclosed herein. In some examples, aspects of the operations of 1815 may be performed by a bandwidth configuration component 1130 as described with reference to FIG. 11.

At 1820, the method may include establishing, in accordance with the communication bandwidth configuration procedure, the sidelink relay communication link between the relay UE and the remote UE using a reduced communication bandwidth that is less than a full communication bandwidth allocated for the relay UE. The operations of 1820 may be performed in accordance with examples as disclosed herein. In some examples, aspects of the operations of 1820 may be performed by a communication link component 1135 as described with reference to FIG. 11.

The following provides an overview of aspects of the present disclosure:

Aspect 1: A method for wireless communication at a relay UE, comprising: transmitting one or more discovery messages associated with establishing a sidelink relay communication link between the relay UE and a remote UE having a reduced communication bandwidth capability relative to the relay UE; performing a communication bandwidth configuration procedure with the remote UE based at least in part on the remote UE having the reduced communication bandwidth capability relative to the relay UE; and establishing, in accordance with the communication bandwidth configuration procedure, the sidelink relay communication link between the relay UE and the remote UE using a reduced communication bandwidth that is less than a full communication bandwidth allocated for the relay UE.

Aspect 2: The method of aspect 1, wherein transmitting the one or more discovery messages comprises: transmitting the one or more discovery messages with broadcast signaling in a resource pool corresponding to the reduced communication bandwidth.

Aspect 3: The method of any of aspects 1 through 2, wherein transmitting the one or more discovery messages comprises: transmitting the one or more discovery messages with broadcast signaling in a resource pool corresponding to the full communication bandwidth allocated for the relay UE.

Aspect 4: The method of any of aspects 1 through 3, wherein transmitting the one or more discovery messages comprises: transmitting a first set of discovery messages with broadcast signaling in a first resource pool corresponding to the full communication bandwidth allocated for the relay UE; and transmitting a second set of discovery messages with broadcast signaling in a second resource pool corresponding to the reduced communication bandwidth.

Aspect 5: The method of any of aspects 1 through 4, further comprising: transmitting an indication, to a base station, indicating that the remote UE has the reduced communication bandwidth capability relative to the relay UE.

Aspect 6: The method of aspect 5, wherein transmitting the indication comprises: transmitting the indication via a dedicated radio resource control message while the relay UE is in a radio resource control connected state with the base station.

Aspect 7: The method of any of aspects 5 through 6, wherein transmitting the indication comprises: transmitting the indication without transitioning to a radio resource control connected state while the relay UE is in a radio resource control idle state or a radio resource control inactive state with the base station.

Aspect 8: The method of aspect 7, wherein transmitting the indication comprises: transmitting the indication via a dedicated logical channel identifier that is configured for indicating that the remote UE has the reduced communication bandwidth capability relative to the relay UE.

Aspect 9: The method of any of aspects 7 through 8, wherein transmitting the indication comprises: transmitting the indication via a radio resource control message associated with the relay UE establishing or resuming a communication link with the base station.

Aspect 10: The method of any of aspects 1 through 9, wherein transmitting the one or more discovery messages comprises: transmitting a cell barring indication in the one or more discovery messages, the cell barring indication indicating one or more receiving chains for the remote UE.

Aspect 11: The method of any of aspects 1 through 10, wherein the remote UE is configured with one or more reduced capabilities relative to the relay UE, the one or more reduced capabilities comprise a limitation on a maximum number of data radio bearers, a lack of support for carrier aggregation, a lack of support for dual connectivity, a limitation on a number of supported receiver chains, or a combination thereof

Aspect 12: The method of any of aspects 1 through 11, wherein the sidelink relay communication link is a PC5 communication link.

Aspect 13: The method of any of aspects 1 through 12, wherein the one or more discovery messages comprises a first indication of whether the relay UE supports the reduced communication bandwidth, the full communication bandwidth, or both for a connection with a base station, a second indication of whether the relay UE supports the reduced communication bandwidth, the full communication bandwidth, or both for a sidelink connection, or a combination of the first indication and the second indication.

Aspect 14: A method for wireless communication at a remote UE, comprising: receiving one or more discovery messages associated with establishing a sidelink relay communication link between a relay UE and the remote UE, wherein the remote UE has a reduced communication bandwidth capability relative to the relay UE; performing a communication bandwidth configuration procedure with the relay UE based at least in part on the remote UE having the reduced communication bandwidth capability relative to the relay UE; and establishing, in accordance with the communication bandwidth configuration procedure, the sidelink relay communication link between the relay UE and the remote UE using a reduced communication bandwidth that is less than a full communication bandwidth allocated for the relay UE.

Aspect 15: The method of aspect 14, wherein receiving the one or more discovery messages comprises: receiving the one or more discovery messages over broadcast signaling in a resource pool corresponding to the reduced communication bandwidth.

Aspect 16: The method of any of aspects 14 through 15, wherein receiving the one or more discovery messages comprises: receiving the one or more discovery messages over broadcast signaling in a resource pool corresponding to the full communication bandwidth allocated for the relay UE.

Aspect 17: The method of any of aspects 14 through 16, wherein receiving the one or more discovery messages comprises: receiving a first set of discovery messages over broadcast signaling in a first resource pool corresponding to the full communication bandwidth allocated for the relay UE; and receiving a second set of discovery messages over broadcast signaling in a second resource pool corresponding to the reduced communication bandwidth.

Aspect 18: The method of any of aspects 14 through 17, wherein receiving the one or more discovery messages comprises: receiving a cell barring indication in the one or more discovery messages, the cell barring indication indicating one or more receiving chains for the remote UE.

Aspect 19: The method of any of aspects 14 through 18, further comprising: selecting the relay UE for establishing the sidelink relay communication link based at least in part on the relay UE supporting the reduced communication bandwidth for a sidelink communication, the relay UE supporting the reduced communication bandwidth for a communication link with a base station, or a combination thereof.

Aspect 20: The method of aspect 19, wherein selecting the relay UE further comprises: selecting the relay UE based at least in part on a priority associated with the relay UE supporting the reduced communication bandwidth for the sidelink communication or the relay UE supporting the reduced communication bandwidth for the communication link with the base station.

Aspect 21: The method of any of aspects 14 through 20, wherein the remote UE is configured with one or more reduced capabilities relative to the relay UE, the one or more reduced capabilities comprise a limitation on a maximum number of data radio bearers, a lack of support for carrier aggregation, a lack of support for dual connectivity, a limitation on a number of supported receiver chains, or a combination thereof

Aspect 22: The method of any of aspects 14 through 21, wherein the sidelink relay communication link is a PC5 communication link.

Aspect 23: The method of any of aspects 14 through 22, wherein the one or more discovery messages comprises a first indication of whether the relay UE supports the reduced communication bandwidth, the full communication bandwidth, or both for a connection with a base station, a second indication of whether the relay UE supports the reduced communication bandwidth, the full communication bandwidth, or both for a sidelink connection, or a combination of the first indication and the second indication.

Aspect 24: An apparatus for wireless communication at a relay UE, comprising a processor; memory coupled with the processor; and instructions stored in the memory and executable by the processor to cause the apparatus to perform a method of any of aspects 1 through 13.

Aspect 25: An apparatus for wireless communication at a relay UE, comprising at least one means for performing a method of any of aspects 1 through 13.

Aspect 26: A non-transitory computer-readable medium storing code for wireless communication at a relay UE, the code comprising instructions executable by a processor to perform a method of any of aspects 1 through 13.

Aspect 27: An apparatus for wireless communication at a remote UE, comprising a processor; memory coupled with the processor; and instructions stored in the memory and executable by the processor to cause the apparatus to perform a method of any of aspects 14 through 23.

Aspect 28: An apparatus for wireless communication at a remote UE, comprising at least one means for performing a method of any of aspects 14 through 23.

Aspect 29: A non-transitory computer-readable medium storing code for wireless communication at a remote UE, the code comprising instructions executable by a processor to perform a method of any of aspects 14 through 23.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a relay user equipment (UE), comprising:
transmitting one or more discovery messages associated with establishing a sidelink relay communication link between the relay UE and a remote UE having a reduced communication bandwidth capability relative to the relay UE;
performing a communication bandwidth configuration procedure with the remote UE based at least in part on the remote UE having the reduced communication bandwidth capability relative to the relay UE; and
establishing, in accordance with the communication bandwidth configuration procedure, the sidelink relay communication link between the relay UE and the remote UE using a reduced communication bandwidth that is less than a full communication bandwidth allocated for the relay UE.

2. The method of claim 1, wherein transmitting the one or more discovery messages comprises:
transmitting the one or more discovery messages with broadcast signaling in a resource pool corresponding to the reduced communication bandwidth.

3. The method of claim 1, wherein transmitting the one or more discovery messages comprises:
transmitting the one or more discovery messages with broadcast signaling in a resource pool corresponding to the full communication bandwidth allocated for the relay UE.

4. The method of claim 1, wherein transmitting the one or more discovery messages comprises:
transmitting a first set of discovery messages with broadcast signaling in a first resource pool corresponding to the full communication bandwidth allocated for the relay UE; and
transmitting a second set of discovery messages with broadcast signaling in a second resource pool corresponding to the reduced communication bandwidth.

5. The method of claim 1, further comprising:
transmitting an indication, to a base station, indicating that the remote UE has the reduced communication bandwidth capability relative to the relay UE.

6. The method of claim 5, wherein transmitting the indication comprises:
transmitting the indication via a dedicated radio resource control message while the relay UE is in a radio resource control connected state with the base station.

7. The method of claim 5, wherein transmitting the indication comprises:
transmitting the indication without transitioning to a radio resource control connected state while the relay UE is in a radio resource control idle state or a radio resource control inactive state with the base station.

8. The method of claim 7, wherein transmitting the indication comprises:
transmitting the indication via a dedicated logical channel identifier that is configured for indicating that the remote UE has the reduced communication bandwidth capability relative to the relay UE.

9. The method of claim 7, wherein transmitting the indication comprises:
transmitting the indication via a radio resource control message associated with the relay UE establishing or resuming a communication link with the base station.

10. The method of claim 1, wherein transmitting the one or more discovery messages comprises:
transmitting a cell barring indication in the one or more discovery messages, the cell barring indication indicating one or more receiving chains for the remote UE.

11. The method of claim 1, wherein:
the remote UE is configured with one or more reduced capabilities relative to the relay UE; and
the one or more reduced capabilities comprise a limitation on a maximum number of data radio bearers, a lack of support for carrier aggregation, a lack of support for dual connectivity, a limitation on a number of supported receiver chains, or a combination thereof.

12. The method of claim 1, wherein the sidelink relay communication link is a PC5 communication link.

13. The method of claim 1, wherein the one or more discovery messages comprises a first indication of whether the relay UE supports the reduced communication bandwidth, the full communication bandwidth, or both for a connection with a base station, a second indication of whether the relay UE supports the reduced communication bandwidth, the full communication bandwidth, or both for a sidelink connection, or a combination of the first indication and the second indication.

14. A method for wireless communication at a remote user equipment (UE), comprising:
receiving one or more discovery messages associated with establishing a sidelink relay communication link between a relay UE and the remote UE, wherein the remote UE has a reduced communication bandwidth capability relative to the relay UE;
performing a communication bandwidth configuration procedure with the relay UE based at least in part on the remote UE having the reduced communication bandwidth capability relative to the relay UE; and
establishing, in accordance with the communication bandwidth configuration procedure, the sidelink relay communication link between the relay UE and the remote UE using a reduced communication bandwidth that is less than a full communication bandwidth allocated for the relay UE.

15. The method of claim 14, wherein receiving the one or more discovery messages comprises:
receiving the one or more discovery messages over broadcast signaling in a resource pool corresponding to the reduced communication bandwidth.

16. The method of claim 14, wherein receiving the one or more discovery messages comprises:
receiving the one or more discovery messages over broadcast signaling in a resource pool corresponding to the full communication bandwidth allocated for the relay UE.

17. The method of claim 14, wherein receiving the one or more discovery messages comprises:
receiving a first set of discovery messages over broadcast signaling in a first resource pool corresponding to the full communication bandwidth allocated for the relay UE; and
receiving a second set of discovery messages over broadcast signaling in a second resource pool corresponding to the reduced communication bandwidth.

18. The method of claim 14, wherein receiving the one or more discovery messages comprises:
receiving a cell barring indication in the one or more discovery messages, the cell barring indication indicating one or more receiving chains for the remote UE.

19. The method of claim 14, further comprising:
selecting the relay UE for establishing the sidelink relay communication link based at least in part on the relay UE supporting the reduced communication bandwidth for a sidelink communication, the relay UE supporting the reduced communication bandwidth for a communication link with a base station, or a combination thereof.

20. The method of claim 19, wherein selecting the relay UE further comprises:
selecting the relay UE based at least in part on a priority associated with the relay UE supporting the reduced communication bandwidth for the sidelink communication or the relay UE supporting the reduced communication bandwidth for the communication link with the base station.

21. The method of claim 14, wherein:
the remote UE is configured with one or more reduced capabilities relative to the relay UE; and
the one or more reduced capabilities comprise a limitation on a maximum number of data radio bearers, a lack of support for carrier aggregation, a lack of support for dual connectivity, a limitation on a number of supported receiver chains, or a combination thereof.

22. The method of claim 14, wherein the sidelink relay communication link is a PC5 communication link.

23. The method of claim 14, wherein the one or more discovery messages comprises a first indication of whether the relay UE supports the reduced communication bandwidth, the full communication bandwidth, or both for a connection with a base station, a second indication of whether the relay UE supports the reduced communication bandwidth, the full communication bandwidth, or both for a sidelink connection, or a combination of the first indication and the second indication.

24. An apparatus for wireless communication at a relay user equipment (UE), comprising:
a processor;
memory coupled with the processor; and
instructions stored in the memory and executable by the processor to cause the apparatus to:
transmit one or more discovery messages associated with establishing a sidelink relay communication link between the relay UE and a remote UE having a reduced communication bandwidth capability relative to the relay UE;
perform a communication bandwidth configuration procedure with the remote UE based at least in part on the remote UE having the reduced communication bandwidth capability relative to the relay UE; and
establish, in accordance with the communication bandwidth configuration procedure, the sidelink relay communication link between the relay UE and the remote UE using a reduced communication bandwidth that is less than a full communication bandwidth allocated for the relay UE.

25. The apparatus of claim 24, wherein the instructions to transmit the one or more discovery messages are executable by the processor to cause the apparatus to:
transmit the one or more discovery messages with broadcast signaling in a resource pool corresponding to the reduced communication bandwidth.

26. The apparatus of claim 24, wherein the instructions to transmit the one or more discovery messages are executable by the processor to cause the apparatus to:
transmit the one or more discovery messages with broadcast signaling in a resource pool corresponding to the full communication bandwidth allocated for the relay UE.

27. The apparatus of claim 24, wherein the instructions to transmit the one or more discovery messages are executable by the processor to cause the apparatus to:
transmit a first set of discovery messages with broadcast signaling in a first resource pool corresponding to the full communication bandwidth allocated for the relay UE; and
transmit a second set of discovery messages with broadcast signaling in a second resource pool corresponding to the reduced communication bandwidth.

28. An apparatus for wireless communication at a remote user equipment (UE), comprising:
a processor;
memory coupled with the processor; and
instructions stored in the memory and executable by the processor to cause the apparatus to:
receive one or more discovery messages associated with establishing a sidelink relay communication link between a relay UE and the remote UE, wherein the remote UE has a reduced communication bandwidth capability relative to the relay UE;
perform a communication bandwidth configuration procedure with the relay UE based at least in part on the remote UE having the reduced communication bandwidth capability relative to the relay UE; and
establish, in accordance with the communication bandwidth configuration procedure, the sidelink relay communication link between the relay UE and the remote UE using a reduced communication bandwidth that is less than a full communication bandwidth allocated for the relay UE.

29. The apparatus of claim 28, wherein the instructions to receive the one or more discovery messages are executable by the processor to cause the apparatus to:
receive the one or more discovery messages over broadcast signaling in a resource pool corresponding to the reduced communication bandwidth.

30. The apparatus of claim 28, wherein the instructions to receive the one or more discovery messages are executable by the processor to cause the apparatus to:
receive the one or more discovery messages over broadcast signaling in a resource pool corresponding to the full communication bandwidth allocated for the relay UE.
